(19) United States
(12) Patent Application Publication
(10) Pub. No.: US 2026/0017059 A1
(43) Pub. Date: Jan. 15, 2026

(54) OFFER-CHOOSE PROCESSOR

(71) Applicant: Intensivate Inc., San Francisco, CA (US)

(72) Inventors: Kevin Sean Halle, San Francisco, CA (US); Armia Faraq, San Francisco, CA (US)

(73) Assignee: Intensivate Inc., San Francisco, CA (US)

(21) Appl. No.: 19/334,642

(22) Filed: Sep. 19, 2025

Related U.S. Application Data
(63) Continuation-in-part of application No. 18/649,817, filed on Apr. 29, 2024.
Application No. 18/649,817 is a continuation of application No. 17/716,981, filed on Apr. 8, 2022, now abandoned.
Application No. 17/716,981 is a continuation-in-part of application No. PCT/US2020/054858, filed on Oct. 8, 2020.
Application No. PCT/US2020/054858 is a continuation-in-part of application No. 16/596,417, filed on Oct. 8, 2019, now Pat. No. 11,321,097.
Application No. 16/596,417 is a continuation-in-part of application No. 15/900,760, filed on Feb. 20, 2018, now Pat. No. 10,437,603.
(60) Provisional application No. 62/460,909, filed on Feb. 20, 2017.
(60) Provisional application No. 62/501,780, filed on May 5, 2017.
(60) Provisional application No. 62/620,032, filed on Jan. 22, 2018.
(60) Provisional application No. 62/911,368, filed on Oct. 6, 2019.
(60) Provisional application No. 62/911,368, filed on Oct. 6, 2019.
(60) Provisional application No. 63/716,229, filed on Nov. 4, 2024.
(60) Provisional application No. 63/722,059, filed on Nov. 18, 2024.

(51) Int. Cl. G06F 9/38; G06F 9/30

(52) U.S. Cl. CPC G06F 9/3838; G06F 9/30123; G06F 9/30141; G06F 9/3802; G06F 9/3836; G06F 9/3851; G06F 9/3877

(57) ABSTRACT

A system can include a plurality of hardware threads, one or more schedulers, and one or more execution pipelines. At least one hardware thread of the plurality of hardware threads can include one or more finite state machines. At least one finite state machine of the one or more finite state machines can be of a first type. The at least one finite state machine can process hazards on instructions. The at least one finite state machine can determine cycles in which the instructions are safe to issue to at least one of the one or more execution pipelines.

### CROSS-REFERENCE TO RELATED PATENT APPLICATIONS

This application is a continuation-in-part of U.S. patent application Ser. No. 18/649,817, filed on Apr. 29, 2024, which is a continuation of U.S. patent application Ser. No. 17/716,981, filed Apr. 8, 2022, which is a continuation-in-part of PCT/US2020/054848, filed Oct. 8, 2020, which is a continuation-in-part of U.S. application Ser. No. 16/596,417, filed Oct. 8, 2019, which is a continuation-in-part of U.S. application Ser. No. 15/900,760, filed Feb. 20, 2018. U.S. patent application Ser. No. 15/900,760 claims the benefit of and priority to U.S. Provisional Patent Application No. 62/620,032, filed Jan. 22, 2017, U.S. Provisional Patent Application No. 62/501,780, filed May 5, 2017, and U.S. Provisional Patent Application No. 62/460,909, filed Feb. 20, 2017. U.S. patent application Ser. No. 16/596,417 claims the benefit of and priority to U.S. Provisional Patent Application No. 62,911,368, filed Oct. 6, 2019. This application also claims the benefit of and priority to U.S. Provisional Patent Application No. 63,716,229, filed Nov. 4, 2024, and U.S. Provisional Patent Application No. 63/722,059, filed Nov. 18, 2024. The entireties of the disclosures of all of the above patent applications are incorporated by reference herein.

### BACKGROUND

The present disclosure relates to the field of computer hardware.

Multi-thread CPUs intended for use in servers typically require a significant overhead in hardware in order to achieve high performance. The added hardware consumes significant amounts of energy for each instruction, which is wasted energy.

### SUMMARY

Various embodiments of the present disclosure include an instruction fetch mechanism within a processor system that has multiple hardware threads by which the processor system executes instructions from multiple software threads in some interleaved fashion. The instruction fetch mechanism fetches an entire cache block (or at least 25, 50 or 75% thereof) from the instruction cache or instruction memory as one unit and stores it into one of a plurality of temporary storage locations, where each of the temporary storage locations is associated with a particular hardware thread. To execute instructions from a particular software thread, the software thread is assigned to a hardware thread and instructions for the software thread are taken from the local instruction storage associated with that hardware thread. When an instruction to be executed is not present in the local storage then a fetch is initiated to fill the local storage.

Various embodiments of the present disclosure include an illustrative example embodiment of a processor system comprising: 1) a register file set including a plurality of physical memory arrays, each of the memory arrays having an access time and plurality of access ports, each register file of the register file set being associated with a different hardware context; 2) a context unit comprising a number of logical rows, each logical row implementing a portion of a hardware thread, a row of the context unit optionally including: a program counter storage or equivalent, an instruction block storage configured to store a block of instructions, logic configured to fetch the block from memory, and logic configured to determine and indicate that an instruction is ready to be issued from the row and offer one or more instructions to logic that chooses from among the offers made by one or more rows; 3) one or more execution pipelines each including at least one execution unit; 4) and issue logic, also known as a scheduler, configured to choose a row from among the one or more rows that are indicating ready to issue an instruction, and to issue an instruction from the selected row to one of the plurality of execution pipelines, wherein the selection of the row is predicated on a ready state of the selected row. Alternatively, the row of the context unit may include an address of an instruction block and (instead of a program counter) include an index into that instruction block.

In an alternative embodiment, the register file set may be accessed at a frequency greater than one divided by the access time of a single register file that is a member of the set, by requiring instructions from the same register file to be spaced apart in time by a minimum of the number of clock cycles required to access that register file.

Various embodiments of the present disclosure include a processor system comprising: an execution pipeline including an execution unit; an instruction cache; a context unit including a plurality of rows, each of the plurality of rows having an independent software thread assigned to it, each of the plurality of rows including storage configured to store one or more instructions, each of the plurality of rows including at least one program counter or alternatively an address of the one or more instructions and an index into the one or more instructions, each of the plurality of rows including logic configured to fetch the one or more instructions from the instruction cache, and each of the plurality of rows including logic configured to determine when an instruction is ready to be issued to the execution pipeline from the respective row and offer the one or more instructions to issue logic; and issue logic configured to choose a row from among the plurality of rows that indicate ready to issue and to issue an instruction from the selected row to the execution pipeline.

Any of the embodiments discussed herein may be applied to systems including one or more types of execution pipelines commonly used for instruction or data processing. For example, an instruction may be issued directly from a row to a memory execution pipeline for load and store instructions, integer execution pipeline for integer arithmetic and logic instructions, floating point execution pipeline for floating point arithmetic and logic instructions, vector execution pipeline for vector style instructions, etc.

In embodiments that include multiple types of execution pipelines there is optionally a separate instance of instruction ready logic in a row for each type of execution pipeline. For example, if there are three types of execution pipeline, then there may be three types of ready logic in a single row, each type of ready logic associated with a specific type of execution pipeline. Different rows are optionally associated with different numbers of types of execution pipelines, as such a row may be specialized. In a given row, the instance of ready logic for a given type of execution pipeline determines when (e.g., a point in time) the next instruction of the given type is ready to be issued from the row to an execution pipeline of the associated type.

In embodiments that include multiple types of execution pipelines there is also optionally a separate instance of issue logic, also known as a scheduler, for each type of execution pipeline. In this case, the issue logic associated with a specific type of execution pipeline chooses from among the rows that have one or more instructions ready for that type of execution pipeline and are therefore offering one or more ready instructions to the issue logic. There can be type specific issue logic attached to each individual execution pipeline instance, and/or there can be type specific global issue logic that selects an instruction of any type from any row and issues that instruction to any execution pipeline that takes that type of instruction. In some embodiments, some types of instructions may be managed by a global instance of issue logic while other types of instructions may be managed by row specific instances of issue logic. Further, there is optionally an instance of ready logic for each type of execution pipeline to which the row can issue.

Various embodiments of the present disclosure may include a method of executing a set of computing instructions, the method comprising: moving instructions associated with a software thread from memory into a context unit row that is associated with the same software thread, the row may include a counter, such as a program counter, and/or logic whose effect is equivalent to the semantics of a program counter, and storage configured to store the moved instructions, wherein there is a plurality of rows, each associated with a different software thread and each row configured as a portion of a hardware thread, and including control logic whose behavior depends upon the history of past actions plus inputs to the system (e.g., the state of previously issued instruction(s)) and having at least two functions, where such control logic is optionally embodied by finite state machines with, a first finite state machine configured to control fetching of one or more next instructions to be executed by an execution pipeline, and moving (fetching) the instruction takes an access time; and each of the plurality of rows including a second finite state machine configured to indicate that an instruction is ready to be issued from the respective row, the second finite state machine in a row determining that an instruction is ready to be issued from the row to an execution pipeline, which involves avoiding “hazards” such as conflicts, dependencies, etc. between instructions in progress attempting to use the same single-use internal resource for example more than one attempting to access the same port of a particular memory array that stores instruction register data (such as a register file); choosing a row by issue logic, also known as a scheduler, from among those that are ready to issue an instruction, and issuing the ready instruction from that row, which involves moving the instruction to the execution pipeline; updating the indicator of which instruction is to be issued next from the row that issued an instruction, to reflect the address of the next instruction to be issued from that row; and executing the instruction using the execution pipeline. In alternative embodiments instructions may be issued from the same row in successive cycles, or there may be constraints that limit the rate at which instructions can be issued to less than one per cycle, or an embodiment may issue more than one instruction in any given cycle.

Various embodiments of the present disclosure include an instruction fetch mechanism within a processor system that has multiple hardware threads by which the processor system executes instructions from multiple software threads in some interleaved fashion. The instruction fetch mechanism fetches an entire cache block from the instruction cache or instruction memory as one unit and stores it into one of a plurality of temporary storage locations, where the temporary storage locations are each associated with a particular hardware thread. To execute instructions from a particular hardware thread, they are taken from the local storage associated with that hardware thread. When an instruction to be executed is not present in the local storage then a fetch is initiated to fill the local storage. Optionally, wherein instructions are issued to the plurality of execution pipelines at a frequency faster than one over an access time of the physical memory arrays, which store the data indicated by register addresses within the instructions. As a non-limiting example, if a register file is implemented with SRAM that requires 2 clock cycles, and there are 4 execution pipelines, and there are 8 rows in a context unit, then 4 instructions may be issued each cycle, one to each of the 4 execution pipelines, which is possible when the instructions come from half of the 8 rows on one cycle and the other half of the 8 rows on the next cycle, and continuing in this fashion, which is an advantage due to keeping the pipelines busy, while using low area and low power SRAM based register files that run at half the rate of the pipelines. Optionally, wherein the state of the first finite state machine is responsive to progress of execution of an instruction through the execution pipeline. Optionally, further comprising partial decoding the instruction while the instruction is in the row and determining a number of clock cycles until it is safe to issue the next instruction from the row, wherein the state of the first finite state machine is responsive to the number of clock cycles.

In various embodiments moving instructions associated with a software thread from memory into a row is performed an entire cache block at a time; optionally the instructions associated with a software thread are moved from system instruction memory to instruction memory assigned to the specific row; optionally the instructions are stored in the instruction memory assigned to the specific row of the context unit, until an instruction is needed that is not in the instruction memory assigned to the specific row; optionally the instructions are only fully decoded after having been assigned from a row to one of the plurality of execution pipelines; optionally an instruction is partially decoded in order for the ready logic to determine that the respective row is ready to issue the instruction; optionally the instructions are stored in their respective row in their original form; and optionally the instructions are stored in their respective row prior to being assigned an execution pipeline.

### BRIEF DESCRIPTION OF THE DRAWINGS

FIG. 1 illustrates a processor, according to various embodiments.

FIG. 2 illustrates a timing diagram of memory port access, according to various embodiments.

FIGS. 3A and 3B illustrate further details of a context unit, according to various embodiments.

FIG. 4 illustrates a memory array, according to various embodiments.

FIG. 5 illustrates methods of executing multiple independent software threads, according to various embodiments.

FIG. 6 illustrates the process of ensuring that an instruction in a row is ready to be issued and then signaling its readiness, according to various embodiments.

FIGS. 7A and 7B illustrate the process of executing an instruction, according to various embodiments.

FIG. 8 illustrates factors relating to the statistics involved with schedulers that choose which instructions to issue to an execution pipeline.

FIG. 9 illustrates the elements of a software thread.

FIGS. 10A and 10B illustrate the elements of a hardware thread and hardware context.

FIG. 11A illustrates a pipeline stage in an instruction pipeline attached to a scheduler which is in turn attached to multiple execution pipelines.

FIG. 11B illustrates a simple core attached to a scheduler which is in turn attached to multiple execution pipelines.

FIG. 12 illustrates multiple instruction pipelines attached to the same scheduler, which in turn is attached to multiple execution pipelines.

FIG. 13 illustrates an instruction pipeline attached to several schedulers which are in turn each attached to an execution pipeline.

FIG. 14 illustrates a classic RISC instruction pipeline.

FIG. 15 illustrates various types of execution pipeline that may be found in CPUs.

FIGS. 16A-C illustrate one non-limiting examples of connecting rows of a context unit to schedulers and connecting the schedulers to execution pipelines, wherein one row is connected to multiple schedulers and multiple rows are connected to one scheduler and one scheduler is connected to one execution pipeline, wherein the three figures are intended to be multiple views of the same circuit.

### DETAILED DESCRIPTION

As used herein the term “independent software threads” is used to refer to distinct software threads, each with its own sequence of instructions executed, wherein the instructions in one software thread's sequence have no ordering relative to the instructions in another software thread's sequence, except for the case of synchronization operations. A synchronization created between two software threads establishes an order between the synchronization operation performed in one software thread versus the synchronization operation performed in the other software thread, but no other order is established between the instructions in one software thread's set versus those in another software thread's set. For example, if a synchronization event takes place between software thread A and software thread B, then all instructions in software thread A that are ordered before the synchronization is executed in A are ordered before all instructions in software thread B that are ordered after the synchronization in B. However, nothing can be said about the order of instructions in software thread A that come before the synchronization relative to instructions in software thread B that also come before the synchronization.

As used herein the term “control status register” is used to refer to a logical mechanism by which an instruction can gain meta-information about the state of the system or affect the state of the system, where the system includes both the processor core and mechanisms outside of the processor core such as interrupt controller, peripherals in the system (e.g., on-chip network), and/or the like. Functions of the control status register include tracking knowledge about past instruction executions, such as the total count of the number of instructions previously executed in the instruction stream, knowledge about the presence of an interrupt request, the ability to clear such an interrupt request, and/or to change the mode of processing or to configure co-processors, and so on.

As used herein the term “finite state machine” is used to refer to control logic that chooses actions based on a particular sequence of previous activity within the system (including, for example, the state of previously issued instructions). Such control logic uses system state to choose between alternative possible actions. A finite state machine is configured to represent a current state based on prior events. The represented state is one of a finite plurality of allowed states. Thus, the implementation may not look like a classic finite state machine. Specifically Fetch FSM 380 and Ready FSM 390 may be implemented in a variety of ways, by logic, the key factor being that the action taken in any given cycle depends upon the state of various things, such as the specific bits of the instruction or instructions that are in Ready Instruction Storage 320, the bits of previously issued instructions, the status of previously issued instructions, the status of fetching from L1 instruction cache 110 and so on.

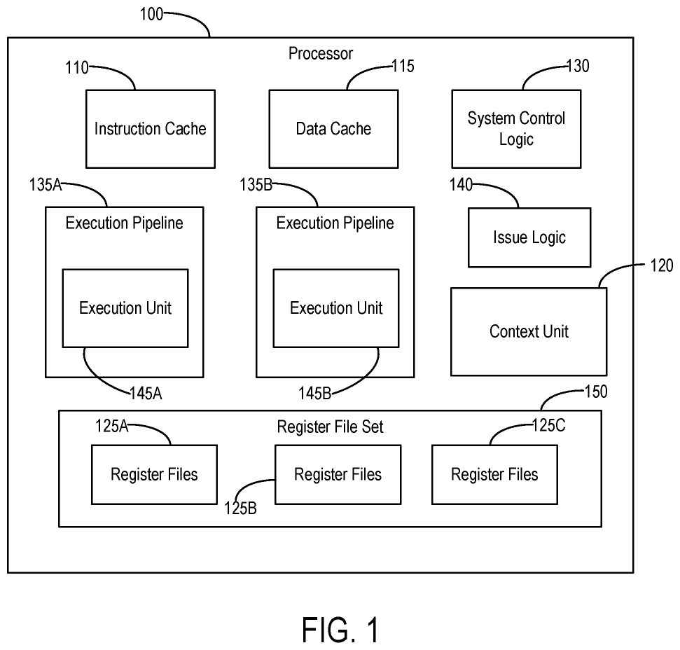

FIG. 1 illustrates a Processor 100, according to various embodiments. Processor 100 includes circuits for executing software instructions. One or more of Processor 100 may be included in a computing device. In various embodiments, Processor 100 is implemented on a silicon chip, or implemented in an FPGA, disposed within a single package or distributed among multiple packages. In some embodiments, more than one of Processor 100 is included in a single package or single chip.

In some embodiments, Processor 100 comprises a register file set 150, a plurality of execution pipelines (shown as execution pipeline 135A and execution pipeline 135B), an instruction cache 110, a data cache 115, system control logic 130, and a Context Unit 120. The register file set 150 can include a plurality of register files (shown as register file 125A, register file 125B, and register file 125C). The execution pipelines 135A and 135B each contain an execution unit (shown as execution unit 145A and execution unit 145B respectively). The execution units 145A and 145B perform calculations such as addition, subtraction, comparison, logical AND, logical OR, and so on. Multiple types of execution unit can be included, such as Floating Point, Vector, and/or the like. A Floating Point execution unit operates on data that encodes a number in the form of a mantissa plus an exponent. A Vector execution unit operates on a group of datums as a single operand. The elements of the group can be floating point format, or integer format, or some other format such as representing graphical data or some custom format.

Processor 100 further includes an optional instruction cache 110 configured to store computing instructions organized into sets. The computing instructions may be executed by two or more different independent software threads. During execution, the computing instructions are typically copied to instruction cache 110 from memory external to Processor 100.

Processor 100 further includes an optional data cache 115 configured to store data to be processed by the computing instructions stored in instruction cache 110. The data stored in data cache 115 contains data that may be copied to and from memory external to Processor 100 and/or may be the result of instruction execution within Processor 100.

Processor 100 further includes one, two or more execution pipelines 135, referenced individually as execution pipeline 135A, 135B, etc. Execution pipelines 135 are configured to execute the operations specified by software instructions. In one possible but not limiting example, execution pipeline 135A may be configured to indicate it is ready for a new instruction, to receive an instruction, to decode the received instruction, obtain data on which the instruction will operate and then pass the instruction and data to execution unit 145A. In another non limiting example, execution pipeline 135A may only perform handshake with issue logic 140 then pass the instruction through to execution unit 145A.

Each execution pipeline (e.g., execution pipeline 135A, execution pipeline 135B, etc.) includes one or more dedicated execution units (e.g., execution unit 145A, execution unit 145B, etc.). Execution units 145 can include an arithmetic logic unit configured to do integer arithmetic and logic, a floating-point logic unit configured to operate on floating point data, a vector logic unit configured to perform vector operations, and/or the like. In some embodiments one or more of execution units 145 are shared by the execution pipelines 135.

Processor 100 further includes a register file set comprising two or more register files 125, individually labeled 125A, 125B, etc. Each of register files 125 is part of a different hardware context. Register files 125 are logical constructs that may be mapped to actual physical memory arrays in a variety of different ways. For example, particular hardware contexts may be mapped to particular physical memory arrays accessible through access ports of the physical memory. A physical memory array may have 1, 2, 3 or more access ports, which can be used independently. Register files 125 are characterized by an “access time.” The access time is the time required to read or write data to or from the register files 125. The access time may be measured in clock cycles or absolute time. Register files 125 can also be implemented by flip flops or latches in combination with decoders and muxes. In some embodiments, a register file can only accept the maximum number of writes, during any given cycle, as the number of write ports that are physically implemented. When more execution pipelines 135 attempt to write to a register file 125 in the same cycle than the number of write ports implemented in that register file, then at least one of the execution pipelines fails in its write attempt. This condition is termed a hazard on the register file. One way of preventing such fails may be to coordinate the issuing of instructions to limit the number of execution pipelines that try to write to a particular register file in the same cycle to be less than the number of write ports that are physically implemented in that register file. In some embodiments, rows of Context Unit 120 may implement logic that takes feedback from execution pipeline 135 and incorporates that feedback in the calculation of hazard conditions and thus affect the signal of whether an instruction is ready for the issue logic 140 to issue to an execution pipeline 135. In summary, a row of Context Unit 120 may implement a portion of a hardware context, in addition to implementing control logic related to a hardware thread, where that control logic may be configured to contain one or more finite state machines and one or more of those finite state machines may initiate fetch of instructions and then may proceed to feed the fetched instructions to a portion of itself or to a separate finite state machine in which logic may implement processing of hazards, for example processing feedback on the progress of previous instructions so as to prevent conflicts among execution pipelines over shared resources such as write ports on register files, and that control logic in turn may signal to issue logic 140 which in turn may issue instructions to execution pipelines 135.

Note that some instructions, when their specified operation is executed by an execution pipeline 135, are able to throw an exception. This happens when the specified operation cannot be performed due to some condition that is defined as an exception by the instruction set architecture specification. Examples include a load or store instruction whose address value fails permissions checks, or whose address value is improperly formed (such as violating alignment), or the op code is not implemented in that logic, and so on. Such an exception may cause the software thread being executed to be suspended and a special software thread that contains code to analyze and respond to the exception is subsequently executed by the associated hardware thread. The control and status registers might be used to save the address of the instruction that caused the exception, which would in turn enable later restarting the software thread that was suspended by the exception. In order to enable restarting the software thread later, any instructions in that software thread that come after the instruction that threw the exception must be prevented from modifying the state of the software thread, where that state is defined in another paragraph. One way to prevent such later instructions from modifying state may be to mute them or to squash them before they reach a point in their execution pipelines at which state modifications happen. When such an approach is taken, the action to prevent modifying state must take place before the point in the execution pipeline that state modification occurs. The number of cycles between the issue of the instruction that throws an exception and the last cycle in which the action to prevent subsequent instructions from modifying state may be one of 1, 2, 3, 4, 5, 6, 7, 8, 9, 10, 11, 12, 13, or 14.

Processor 100 further includes a Context Unit 120. Context Unit 120 includes a plurality of collections of logic and state, each such collection referred to herein as a “row”, where each row is associated with a different hardware context, and the hardware context is in turn associated with a hardware thread (see elsewhere in this disclosure for the definitions of “row”, “hardware context” and “hardware thread”).

Context Unit 120 is configured to hold instructions in the rows until the instructions are ready to be executed using one of execution pipelines 135. Issue logic 140 is configured to control the issuance of instructions from the rows of Context Unit 120 to members of execution pipelines 135.

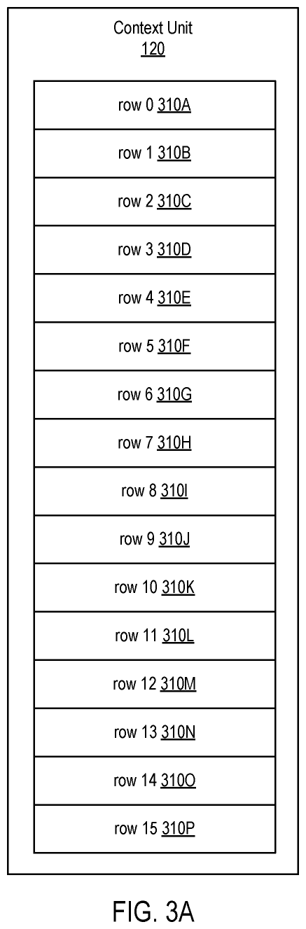

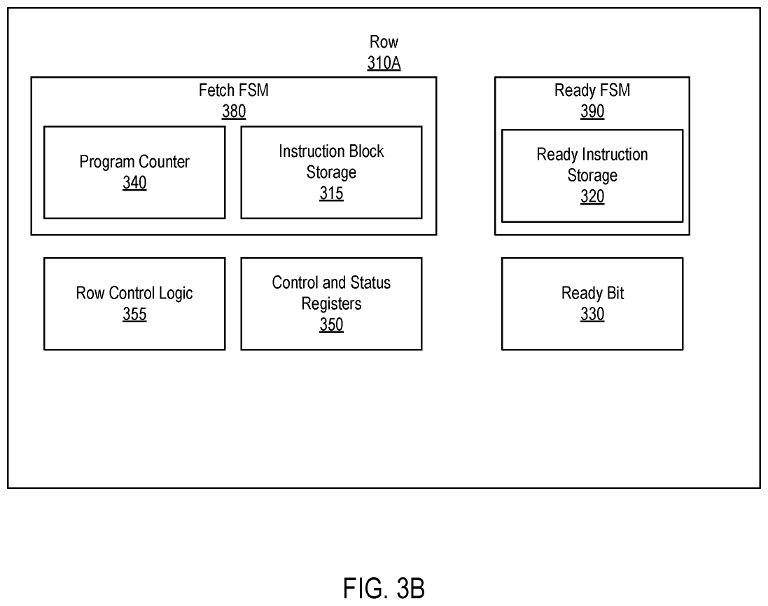

FIGS. 3A and 3B illustrate further details of Context Unit 120, according to various embodiments. Context Unit 120 includes a plurality of Rows (shown as row 310A in FIG. 3A and rows 310A-310L in FIG. 3B), individually identified as Row 310A, Row 310B, etc. Each of Rows 310 is associated with a different hardware context and therefore associated with a different hardware thread. As such, each of Rows 310 is assigned to execution of a different independent software thread. Context Unit 120 includes at least two Rows 310, and can include, for example, 2, 4, 8, 16 or 32 rows, or any number of rows between these values. In some embodiments, Context Unit 120 includes more than 32 rows. Rows 310 may be mapped to any configuration of physical memory and physical logic. In some embodiments, Rows 310 are disposed within Processor 100 to minimize time and/or power required to move instructions from Rows 310 to execution pipelines 135.

FIG. 3A illustrates further details of a Context Unit 120 including a plurality of Rows 310. While the Rows 310 of Context Unit 120 are referred to as “rows,” the contents thereof do not necessarily need to be disposed in a row physical structure. Each Row 310 may be a logical mapping to physical memory and physical logic in a variety of alternative structures.

FIG. 3B illustrates further details of Row 310A of Context Unit 120, as an example of a typical member of Rows 310, according to various embodiments. A Row 310A contains an Instruction Block Storage 315. Instruction Block Storage 315 can include, for example, memory configured to store 1, 2, 4, 8, 16 or other desired number of instructions. Instructions are transferred to Instruction Block Storage 315 from instruction cache 110 or instruction memory external to Processor 100. The transfer of instruction blocks is limited by the access time of the instruction cache 110 or instruction memory external to processor 100. Transfer from optional instruction cache 110 or directly from external instruction memory to Instruction Block Storage 315 is controlled by history dependent control logic within each row that is optionally configured as a Fetch FSM 380. When the next instruction to be issued from a row of context unit 120 is not present in Instruction Block Storage 315 then Fetch FSM 380 issues a request to instruction cache 110 to fetch a new block of instructions. Arbitration logic that is contained within system control Logic 130 ensures that no greater number of accesses are presented to instruction cache 110 in a given cycle than the maximum number that instruction cache 110 can initiate each cycle. System control logic 130 is configured to manage the transfer of instruction blocks from instruction cache 110. For example, system control logic 130 is configured to transfer blocks of instructions coming out of instruction cache 110 to the appropriate row.

Ready Instruction Storage 320 is a logical element that may be a storage for one instruction expected to be issued next, or it may be an output of logic that selects an instruction from Instruction Block Storage 315 or similar. Note that there may be more than one instruction in Ready Instruction Storage, and each may have its own Ready Bit indicator.

A portion of row control logic 355 within Row 310A may be configured to be part of Fetch FSM 380 and may request transfer of instructions from instruction cache 110. Fetch FSM 380 may be further configured to select the next instruction to issue out of Instruction Block Storage 315. Fetch FSM 380 is further configured to hand instructions to Ready FSM 390. Fetch FSM 380 may receive signals from the execution pipeline that indicate when a control flow instruction, e.g., an instruction that can control an order in which instructions are executed, from that row is being executed in the execution pipeline, and it receives notice when that control flow instruction has resolved, e.g., when the order of instruction execution is determined. If the control flow instruction has caused a change in flow, then the address of the new instruction may be sent from execution pipeline 135A to Fetch FSM 380. When the next instruction to issue from the row has an address that is not in Instruction Block Storage 315 then Fetch FSM 380 may send a request to instruction cache 110 to send a block of instructions that includes the next instruction to issue. Those instructions may be placed into Instruction Block Storage 315. Fetch FSM 380 may then notify Ready FSM 390 that one or more next instructions are available for FSM 390 to process.

A portion of control logic 355 within Row 310A may be configured as part of Ready FSM 390 and may be configured to determine when the next instruction is ready to be issued from Row 310A. Ready FSM 390 may optionally be configured to prevent access to a particular physical memory array port within register file 125, that is associated with the same hardware context as the Row 310 that contains Ready FSM 390, from happening more than once within the access time of the respective memory array. Specifically, if the access time of a particular physical read Port 420A is X clock cycles, then Ready FSM 390 may be configured to require a delay of at least X clock cycles between starts of instructions that would access the same read Port 420A.

Using this requirement, even for the optional configuration in which register files require longer than one cycle to access, execution pipelines 135 can still be configured to access the register file set 150 more than one time during the access time of a particular physical memory array, i.e., at a frequency greater than one divided by the access time of a particular memory array. Alternative embodiments include the use of a register file structure that has many ports, or a register file structure that has pipelining or a register file structure that has forwarding from write ports to read ports, or by the use of register renaming, or alternative embodiments that enable issuing one or more instructions every cycle from the same row of Context Unit 120. Likewise in alternative embodiments the fetch FSM 380 may hand one, two, or more instructions in a cycle to ready FSM 390. Ready FSM 390 may hold one, two, or more instructions and ready FSM 390 determines the status of ready or not on each instruction it holds on each cycle. An instruction held by ready FSM 390 may become ready on one cycle then have ready status taken away (set to false) on a subsequent cycle and then ready status again asserted on a cycle after that.

Note that Fetch FSM 380 and Ready FSM 390 are illustrated as separate finite state machines for the purposes of clear and simple explanation. In practice, the logic of the two may be combined into a single logical entity, or the entire context unit 120 may combine all rows and functionality within those rows into a single large interconnected implementation, or whatever organization is convenient for the designers and implementers.

Some embodiments include multiple memory arrays (shown as memory array 410A and memory array 410B), within register file set 150, and employ control logic inside of Ready FSM 390 that ensures that no two instructions will attempt to use the same port of the same physical memory array in an overlapped fashion. In such optional embodiments, for successive instructions that may be issued from Context Unit 120 to execution pipelines 135 those instructions may be carefully chosen such that the particular register entries to which their reads and writes are mapped will access different Ports (shown as read port 420A, read port 420B, read port 420C, read port 420D, etc.) than any read or write that they will overlap with in time.

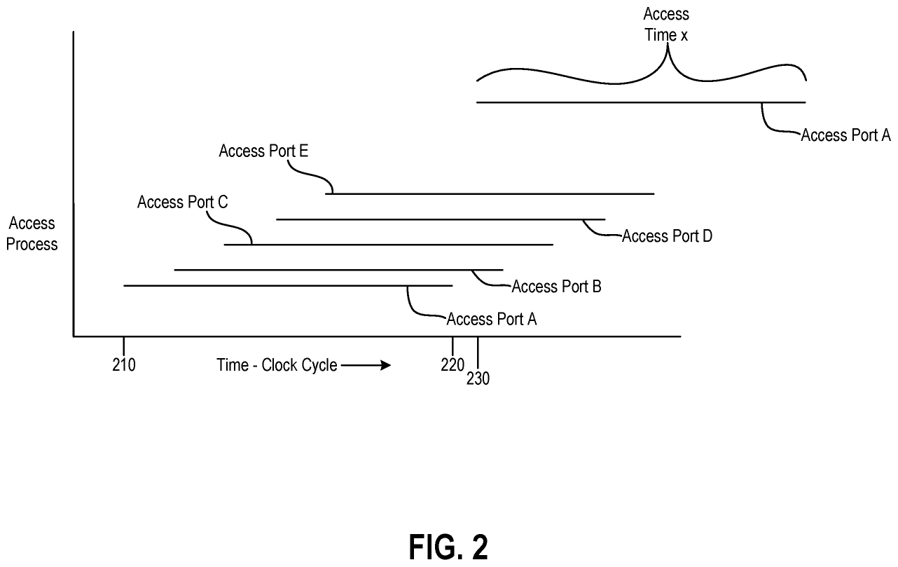

FIG. 2 illustrates a timing diagram of memory port access, according to various optional embodiments. Horizontal lines indicate the time during which a particular port is accessed. The length of the lines represent the access times (X) for the respective ports. The ports shown, A-E, may be divided among multiple memory arrays. A memory port A is first accessed at a Time 210 and the access is completed at a Time 220. Between Time 210 and Time 220, access to Ports B-E are initiated but not necessarily completed. Another attempt to access Port A is not made until a Time 230, which comes after Time 220. Memory port B may be accessed less than X clock cycles after a read operation is initiated at memory port A. This optional staggered approach to register access allows register read and write operations in parallel at a frequency greater than would be possible if only a single port was being accessed.

Processor 100 further includes issue logic 140. Issue logic 140 is configured to select a Row 310 from within Context Unit 120 and to issue an instruction from the selected row to one of execution pipelines 135. It also issues the address of the instruction, which optionally is the value of Program Counter 340, and the number of the row from which the instruction comes. The number of the row that the instruction is taken from may also be referred to as the context ID or ctxt ID. This ID may enable logic in the execution pipelines 135 to later select the proper register file into which to write results, and may enable informing the proper row of context unit 120 of the status of the instruction as the instruction proceeds through the execution pipeline.

Issue logic 140 may be configured to make the selection in response to an indication from one of the execution pipelines 135 that the execution pipeline 135 is ready for a next instruction. The selection is based on the selected row being in a “ready state.” As discussed further elsewhere herein, the ready state is optionally indicated by a “ready bit” or ready signal. When in the ready state, a row is ready to issue the next instruction in an associated independent software thread. The position of that instruction within memory may be indicated by Program Counter 340 or equivalent.

The identifier of the hardware context that the instruction is issued from is also sent to the execution pipeline together with the instruction and the program counter value. In some embodiments, the identifier of the hardware context is an identifier of the row from which the instruction is issued.

In some embodiments, each of the execution pipelines 135 includes one specific type of execution unit 145. In these embodiments, the selection of a Row 310 from which to issue an instruction is optionally further dependent on a match between the type of instruction that the execution unit 145 is configured to process and the type of instruction ready to be issued from particular members of Rows 310. This approach may require that the instructions be at least partially decoded while in Rows 310. In this approach Ready FSM 390 may perform the partial decode or issue logic 140 may perform the partial decode or some other arrangement.

In some embodiments, the source register addresses may be extracted from the instruction prior to issuing the instruction, and the extracted addresses also sent to the register file associated with the software thread, prior to issuing the instruction. Doing so provides additional time for the data in the register file to be accessed and sent closer to the execution pipeline, which in turn enables higher clock speed and lower energy circuit choices. This may be done by a ready FSM or by other logic in a Row 310 or by issue logic 140 or some related logic that has access to the instruction bits prior to issue of the instruction.

In alternative embodiments, instructions may be issued to execution pipeline 135A without regard to the type of execution unit(s) 145A associated with that particular execution pipeline. In this case, it may be discovered, after decoding an instruction, that the instruction is of the wrong type for execution unit 145A. As a result, execution pipeline 135A may transfer the instruction after decode to a different member of the plurality of execution pipelines 135, which contains the appropriate type of execution unit 145 for the instruction or execution pipeline 135A may contain multiple execution units and execute the instruction in one of the execution units whose type matches the type of the instruction, or some other approach to ensuring the instruction is executed by an execution unit of the appropriate type.

In some embodiments, Processor 100 includes a different instance of issue logic 140 for each type of execution pipeline 135. In these embodiments, each instance of issue logic selects only instructions of the type appropriate for the execution pipeline(s) to which it is attached. Optionally, each of execution pipelines 135 is associated with its own instance of issue logic 140.

Row 310A further includes a Ready Bit 330. Ready Bit 330 is configured to be used by issue logic 140 to select a row from among the plurality of Rows 310 and to issue an instruction from the selected Row 310 to one of a plurality of execution pipelines 135. On each clock cycle, issue logic 140 is configured to scan the Ready Bits 330 of rows 310, and selects from among the ones that have their Ready Bit 330 asserted. The selected row may have the ready instruction taken from Ready Instruction Storage 320 and sent to one of execution pipelines 135. Thus, the issue logic 140 is responsive to a Ready Bit 330 asserted by Ready FSM 390 included in the selected row. If not, all execution pipelines take the same format of operand, then issue logic 140 may optionally ensure that the instruction is of the correct format for the execution pipeline to which it is issued. Note that Ready Bit 330 may be indicative of a bit of storage or ready bit 330 may be a signal generated by logic, such as the output of logic that computes the ready state.

Each of Rows 310 further may include a Program Counter 340. When an instruction is issued to an execution pipeline 135, it may be accompanied by the address at which that instruction resides within the memory address space. Program Counter 340 may be configured to hold this address. A portion of the control logic 355 that may be inside of Fetch FSM 380 may be configured to update the contents of Program Counter 340 to ensure that the contents are correct when an instruction is issued. The content of the respective Program Counter 340 (e.g., the memory address) may be sent to execution pipeline 135 together with each instruction issued from a member of Rows 310.

Each of Rows 310 optionally further includes Control/Status Registers 350. Control and Status Registers 350 can include memory configured to store data indicative of a status of processor 100 and/or serve as a port to control operation of processor 100. Control and status registers serve as an interface mechanism that allows instructions to access meta information about the system and to manipulate the system. Such meta information includes, for example, the presence of a request for an interrupt, the cause of such a request, status information such as the total number of instructions executed by the software thread since the last reset. Performing a write operation on a Control and Status Registers 350 may be used for: clearing a request for interrupt, changing the operating mode of an execution pipeline or co-processor, and/or the like. Some of the Control and Status Registers 350 are shared between multiple Rows 310, for example the control register that is used to access the real time clock, while other control and status Registers 350 are specific to individual members of Rows 310, for example the status register that is used to access the total number of instructions that have been completed from that row.

Each of Rows 310 further includes a Fetch FSM 380. Fetch FSM 380 is configured to manage blocks of instructions within Row 310A. This management includes, for example, issuing a request to fetch a new block of instructions from instruction cache 110, storing a received block of instructions in Instruction Block Storage 315, updating Program Counter 340 to ensure that it holds the correct memory address when an instruction is issued from Row 310A, placing an instruction in Ready Instruction Storage 320, and sending signals to Ready FSM 390 (discussed further elsewhere herein). Specifically, Fetch FSM 380 is configured to fetch a block of instructions from instruction cache 110 whenever the next instruction to issue from the row is not present in instruction block storage 315. This condition can occur in many ways, including when all the instructions in Instruction Block Storage 315 have been processed or when a branch has been taken to an instruction not yet in Instruction Block Storage 315. Fetch FSM 380 is configured to increment Program Counter 340 if the next instruction in the block of instructions is the next instruction to be executed, or if a control flow instruction has occurred in the software thread, to store the computed target address of a branch or jump into Program Counter.

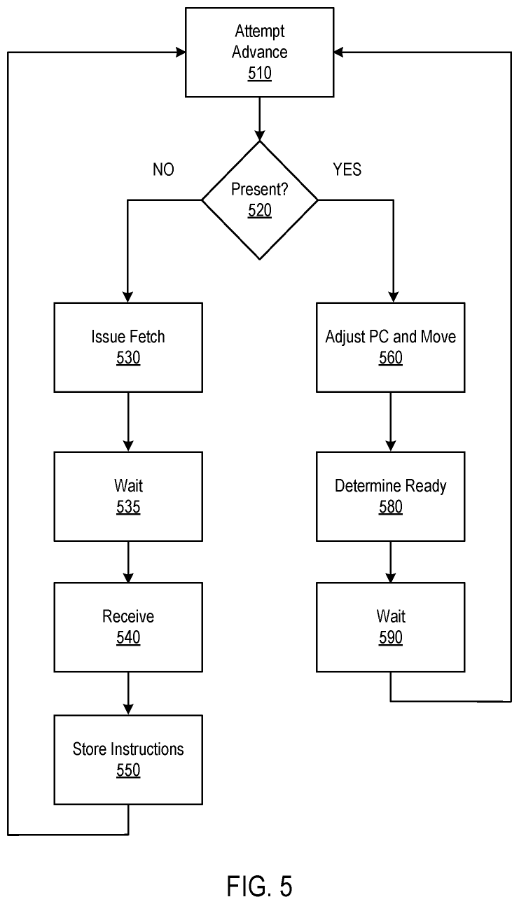

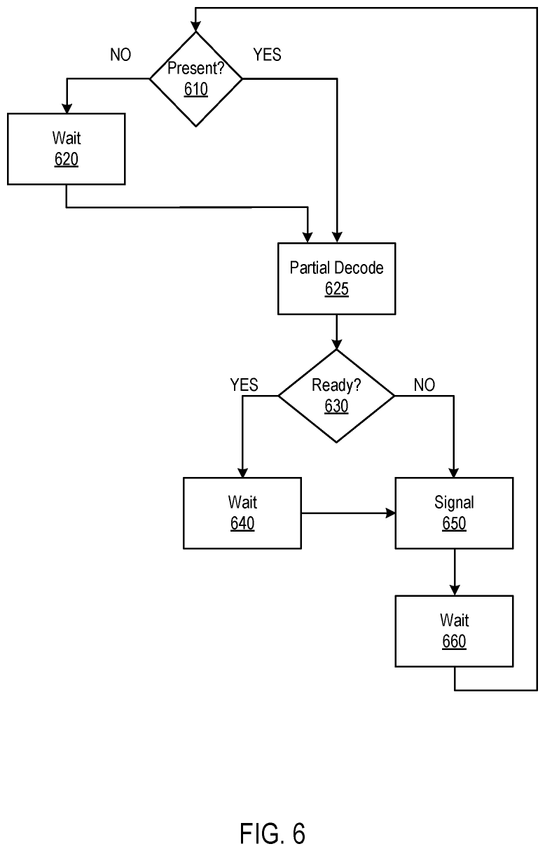

Fetch FSM 380 may be configured to place an instruction in Ready Instruction Storage 320. Ready Instruction Storage 320 may be its own separate storage element, or it may be a system that selects one particular instruction out of Instruction Block Storage 315 or some other arrangement the effect of which may be to allow the bits of the instruction to be examined by control logic within the Row or elsewhere and or allow the instruction to be taken by issue logic 140. Ready Instruction Storage 320 serves as the portal from which instruction issue logic 140 takes the instruction when it is issued from the row. If a next instruction is placed in Ready Instruction Storage 320 this fact may be communicated to Ready FSM 390. Details of the requirements to place an instruction in Ready Instruction Storage 320, and indicate that the instruction is present, are discussed elsewhere herein. Sec, for example, FIGS. 5 and 6.

Each of Rows 310 further includes Ready FSM 390. Ready FSM 390 may be configured to control the issuance of instructions from Row 310A to one or more execution pipelines (e.g., execution pipelines 135A or 135B). Typically, the issued instruction is the one stored in Ready Instruction Storage 320 for the respective Row 310 or the equivalent. In some embodiments, Ready FSM 390 may be configured to track the execution progress of previous instructions from the same software thread or optionally from other software threads and may optionally receive information regarding the types of previous instructions and the type of the instruction to be issued next. Based on the type and progress of previous instructions Ready FSM 390 may be configured to indicate when the instruction in Ready Instruction Storage 320 is ready to be issued to an execution pipeline for execution. One criterion for the instruction being ready to issue may be that Fetch FSM 380 first indicates that the next instruction to issue is currently available in Ready Instruction Storage 320. If Ready FSM 390 determines that instruction in Ready Instruction Storage 320 is ready, it may signal this readiness by setting Ready Bit 330 accordingly.

Processor 100 further includes system control logic 130. System control logic 130 may manage system level control operations, including managing requests made to instruction cache 110 and data cache 115. System control logic 130 may arbitrate among multiple requests made to the caches. System control logic 130 may also track an identifier of the row from which an instruction was issued. System control logic 130 may also manage sending signals between elements of Processor 100 that relate to the status of instruction execution. For example, system control logic 130 may detect when a memory operation has completed access to data cache 115 and send a signal indicating completion to the row that the instruction came from, and optionally an identifier of which instruction completed.

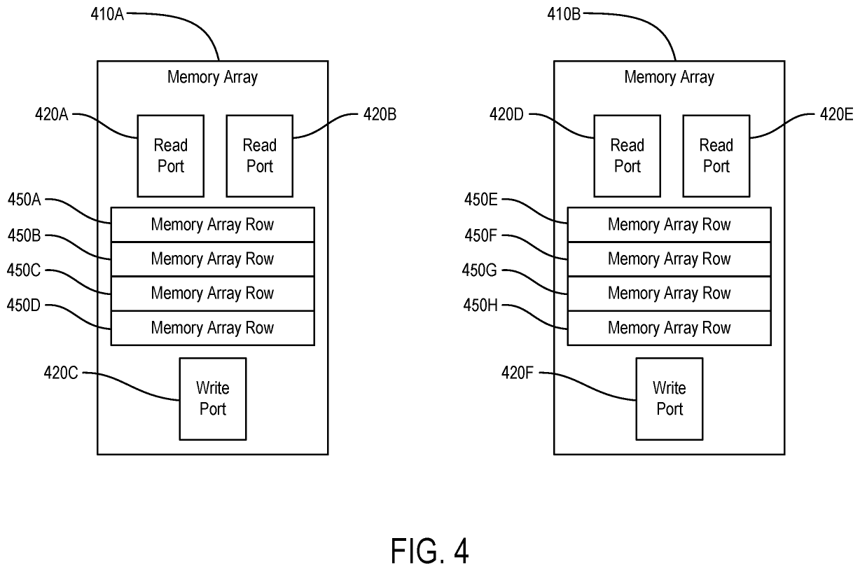

FIG. 4 illustrates two memory arrays (shown as memory array 410A and memory array 410B, which each have three Ports 420, individually labeled 420A-420E, through which to access the contents of the memory array rows 450A through 450H. Processor 100 further includes a plurality of memory arrays (e.g., memory array 410A, memory array 410B, etc.) which may be used to implement the register files 125 and may be used within instruction cache 110 and data cache 115 and elsewhere. Memory array 410A and/or memory array 410B can be implemented as an SRAM array, an array of flip flops, an array of latches, or an array of specialized bit cells designed for use as register file memory. The arrays are optionally implemented with physical means to access the contents of memory array rows 450, which is generally termed a Port 420. For example, memory array 410A has two read Ports (420A & 420B) and one write Port 420C, which may allow one or two read operations to be taking place at the same time and may also allow a write to be taking place at the same time. Additional read ports may be alternatively implemented with multiple instances of memory array 410A in which the contents of each array are copies of each other, allowing multiple copies to be read independently. Larger arrays may be implemented with multiple instances of memory array 410A together with multiplexors that decode address bits and select the appropriate one of the multiple instances, and so on.

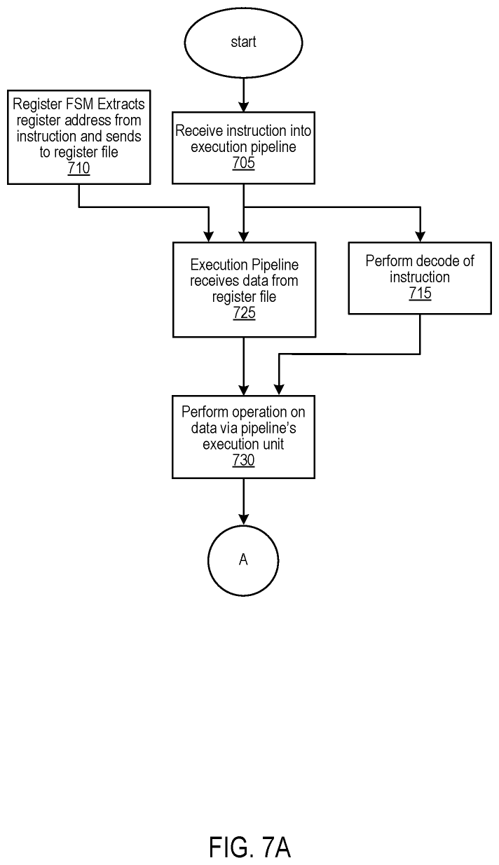

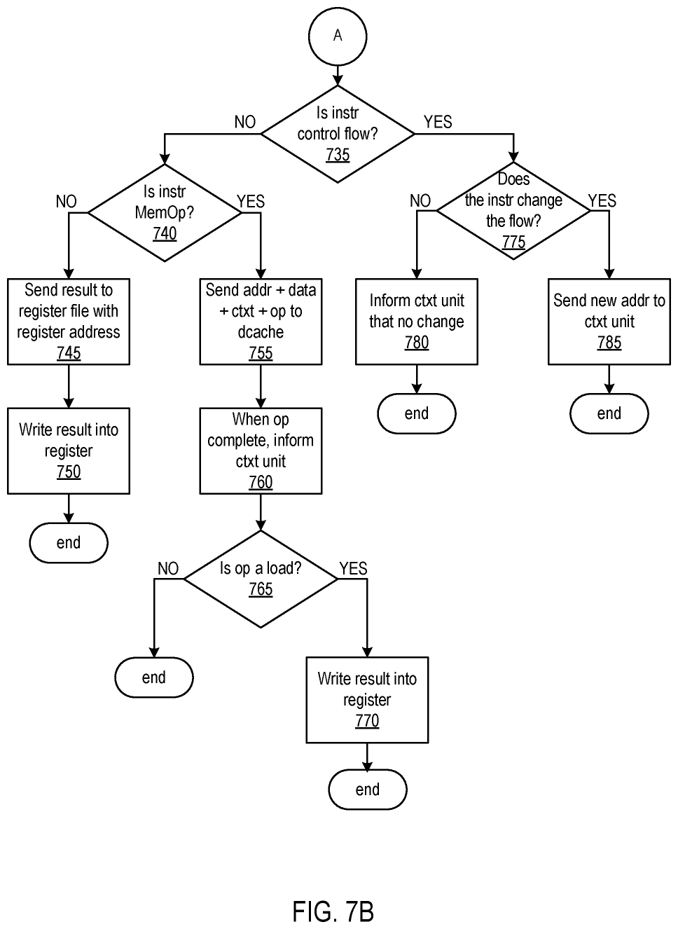

FIGS. 5, 6, 7A, and 7B illustrate optional, non-limiting, methods of executing multiple independent software threads, according to various embodiments of this disclosure. The methods can include multiple concurrent processes that interact. FIG. 5 illustrates the process of fetching instructions from the memory system into a Row 310. FIG. 6 illustrates the process of ensuring that an instruction in a row is ready and then signaling its readiness. FIGS. 7A and 7B illustrate the process of executing an instruction and signaling its progress and outcome.

FIG. 5 illustrates one possible alternative process of fetching instructions from the memory system into a Row 310. The process may begin at an Attempt Advance Step 510 where Fetch FSM 380 attempts to advance to the next instruction in Instruction Block Storage 315. This step may fail if the next instruction to execute in the software thread has an address that is outside the addresses of the instructions in Instruction Block Storage 315.

In Present? Step 520 a next action may be chosen based on whether the advance to the next instruction was successful. If not successful, then the next step may be Issue Fetch step 530 wherein a fetch request is issued.

Issue Fetch Step 530 may occur when the next instruction to execute in the software thread is not present in the local Instruction Block Storage 315 of the respective Row 310. In step 520, fetch FSM 380 may issue a fetch request to instruction cache 110. One or more of the Rows 310 may issue requests in overlapped fashion, however instruction cache 110 may only be able to process fewer requests than are issued. To handle this case, system control logic 130 may include arbitration logic that organizes the sequence of requests entering instruction cache 110.

In a Wait Step 535 the system may wait for the instruction cache 110 to retrieve/provide the indicated instructions. This may involve a cache miss, in which case the instruction may be fetched from memory outside of Processor 100. A cache miss requires some amount of time to complete the request.

In a Receive Step 540, a block of instructions is received from instruction cache 110.

In a Store Instructions Step 550, the received block of instructions is stored into Instruction Block Storage 315 of the respective Row 310. Once Store Instructions Step 550 is complete, the method returns to step 510.

At Present? Step 520, if the answer is yes, then steps 560 and 570 may be performed and they may be performed in parallel.

In an Adjust PC Step 560, the program counter 340 or logic that has the equivalent effect of a program counter, which may alternatively include logic that shifts the instructions or sequences through the instructions or otherwise selects from among the instructions in Instruction Block Storage 315, may be adjusted, so that a next instruction (or more than one) and the corresponding address may become present in Ready Instruction Storage 320. This step may involve synchronization between the fetch finite state machine (fetch FSM 380) and the ready finite state machine (ready FSM 390). The fetch FSM 380 may signal when one or more instructions are available, and the ready FSM 390 may accept them into ready instruction storage 320 as space becomes available in ready instruction storage 320, which may be subject to constraints on grouping of the instructions in the ready FSM 390 that may be required in order for the computed result to match the semantics of the software thread.

In a Determine Ready Step 580, the ready FSM 390 may determine when it may be safe to issue each of the one or more instructions present in ready instruction storage 320. The ready status of the one or more accepted instructions may be determined based on at least one of: 1) conflicts on a register write port; 2) conflicts on a register read port; 3) conflicts in the addresses of instructions that are of the memory operation type; 4) back pressure associated with issuance of instructions; 5) an exception risk associated with a previous instruction; 6) conflicts between one or more addresses among memory operations of instructions in the software thread, or other factors specific to details of the implementation of the execution pipelines and design choices in the logic of the system.

In a Wait Step 590, the process may wait for a signal from issue logic 140 that may indicate that the row has been chosen to issue an instruction. Once this signal is received, the system may loop to Step 510 to attempt to advance to making the next instruction or instructions in the instruction stream become present in the ready instruction storage 320.

In alternative embodiments, zero, one, or more than one instruction may be transferred between the fetch FSM 380 and the ready FSM 390 in each cycle. In addition, zero, one, or more than one instruction may be marked as ready by the ready FSM 390 in each cycle. In addition, the ready status may be revoked on zero, one, or more than one instructions in each cycle, and then restored in following cycles, then revoked again and so on, as conditions within the processor system change.

FIG. 6 illustrates one example of a process of ensuring that an instruction in a row is ready to be issued and then signaling its readiness. This process optionally takes place in each of the rows 310 simultaneously and/or in parallel. Once started, each of the rows 310 may continue this process endlessly until the processor system is reset. Optionally some configuration may be performed that disables one of the Rows 310, such as through the control and status registers 350.

In a row, the process may begin at Present? Step 610, where a check may be performed of whether there is an instruction in ready instruction storage 320.

If no instruction is present, then the ready FSM 390 may signal not-ready status to issue logic 140 and go to Wait Step 620 where the ready FSM 390 may wait until an instruction is supplied by the Fetch FSM 380 and an instruction is once again present in ready instruction storage 320. Then the process may proceed to partial decode step 625.

If the instruction is present in Present? Step 610, then the process may proceed directly to partial decode step 625.

In partial decode step 625, the type of instruction is determined and optionally its source register addresses are extracted and sent to the register file 125. In addition information about the instruction type and bits of the instruction may be extracted and then used during the subsequent Ready? Step 630.

After partial decode step 625, the process may proceed to a Ready? Step 630. Ready? Step 630 may involve 1) the type of the instruction that was extracted during partial decode step 625, 2) multiple elements from the Row 310, 3) elements from the execution pipelines to which previous instructions from the row 310 may have been issued, 4) details of instructions previously issued from the row 310, such as the addresses of memory operations, destination registers of the instructions, and the positions of those instructions within the execution pipelines.

In Ready? Step 630, checks may be performed for hazard conditions (involving the instruction or instructions in Ready Instruction Storage 320) and potential interactions with instructions that were previously issued from the same member of Rows 310. Step 630 can also include checks for stall or backpressure signals from one or more of the execution pipelines, and other conditions that may prevent issuing another instruction from that member of the Rows 310. Such interference can include conditions such as whether the port of the physical memory array accessed by the registers specified in the instruction present in the ready instruction storage 320 will be in use by a different instruction if instruction in ready instruction storage 320 were to be issued on the next cycle. Another example may be when the instruction in the ready instruction storage 320 is a memory access instruction, but there is a previous memory access instruction from the same Row 310 that is still being executed and is a write operation to the same address and the memory execution pipeline does not include a mechanism to forward the value being written by the previous instruction to the instruction currently in the ready instruction storage 320.

The ready status of the one or more accepted instructions may be determined based on at least one of: 1) conflicts on a register write port; 2) conflicts on a register read port; 3) conflicts in the addresses of instructions that are of the memory operation type; 4) back pressure associated with issuance of instructions; 5) an exception risk associated with a previous instruction; 6) conflicts between one or more addresses among memory operations of instructions in the software thread, or other factors specific to details of the implementation of the execution pipelines and design choices in the logic of the system. Such conflict patterns are known in the art as hazard conditions or just hazards.

If there is at least one hazard condition present, then the process may proceed to Wait Step 640. In Wait Step 640, the ready FSM 390 may wait until all hazards and other blocking conditions have resolved. The ready FSM 390 may detect the presence of hazard conditions and their resolution by receiving signals from a plurality of other portions of Processor 100 where those signals indicate the status of instructions that were previously issued. Examples of such signals may include the system control logic 130 sending, upon completion of the access by the data cache 115, a signal indicating completion of a memory access instruction, to the row 310 that issued the instruction. The system control logic 130 may track the row from which each instruction is issued and may use this information to deliver the signal to the correct row 310. The ready FSM 390 in the row that received the signal may then update its state due to receipt of the signal. If receipt of that signal clears that source of hazard condition associated with the instruction in the ready instruction storage 320 and If there are no other hazard or blocking conditions then the ready FSM 390 may stop waiting and the process may proceed to a Signal Step 650.

In Signal Step 650, the ready bit 330 may be asserted, which is the signal to issue logic 140 that may inform issue logic 140 that the row 310 that contains the ready bit 330 is ready to have the instruction that is held in the ready instruction storage 320 to be issued to an execution pipeline. The process may then proceed to a wait Step 660.

In Wait Step 660, the ready FSM 390 may wait for the member of Rows 310 that contains the instruction to be selected by issue logic 140. Issue logic 140 may provide a signal to the ready FSM 390 when issue logic 140 selects the Row 310 that contains it. When the wait is over, the process may loop back to Present? Step 610.

FIGS. 7A and 7B illustrate one example of the process of executing an instruction and signaling its progress and outcome. This process may begin at the start stage in each of execution pipelines 135 in each cycle in which an instruction is issued to the execution pipeline.

In a Receive Instruction Step 705, a valid instruction may be received into execution pipeline 135A. The instruction may be transferred from a selected member of Rows 310 by issue logic 140. In one optional embodiment, the fetch of register contents step 710 may be started while the instruction was held in ready instruction storage 320 and may complete at the point that the instruction enters the execution pipeline. The process may next go to a Receive register contents from register file step 725 and may also go to a decode step 715, optionally in parallel.

In Extract Register Addresses Step 710, bits may be extracted from the received instruction. Most instructions of most instruction set architectures specify one or more registers that hold the inputs to the instruction's operation. The extracted bits identify the logical registers that hold the data to use as input to the execution unit. The bits that indicate the address of a register may be sent to register file set 150 where they may be used to access a particular location from a particular memory array through a particular memory port. The process may then proceed to a receive data from register file Step 725.

In Decode Step 715, the received instruction may be decoded, which may determine the type of instruction, the control bits to apply to the execution unit, and/or the like. The type of instruction sometimes determines how many clock cycles the instruction will take and, thus, may inform FSM 390 about potential hazard conditions for any following instructions. Optionally a partial decoder and counter may be placed in Ready FSM 390 that counts down the number of clock cycles until interference with this type of instruction is no longer possible, or other implementations that take into account the number of cycles until this instruction writes to the register file or the number of cycles until other points of contention take place.

In a receive data from register file Step 725, the data to be operated upon may be received by execution pipeline 135A and may be used as input to the execution unit 145A that is inside execution pipeline 135A.

In a Perform Operation Step 730, the instruction may execute in execution unit 145.

A Flow Control Step 735 is a decision point in the process. If the instruction is not a control flow type, then the next step may be step 740. If it is a control flow type then the next step may be step 775. A flow control type is a type of instruction that can control the order in which instructions are executed.

A MemOp? Step 740 is a decision point in the process. If the instruction type is not a memory operation such as a load instruction or a store instruction then the next step may be a Send Result Step 745. If it is a memory operation then the next step may be a Send MemOp Step 755.

Send Result Step 745 is for a non-control flow and non-memory operation. For this type of instruction, a result of execution may normally be generated by the execution unit 145, and this result may be sent to the register file set 150 by system control logic 130. The next step may be a Write Result Step 750.

In optional alternative implementations, there may be multiple execution pipelines, each for a subset of instruction types. One example would be the addition of a floating point execution pipeline. In this case, there is an additional register file set, which holds floating point formatted data. In this case, the result would be sent to the floating point register file associated with the row from which the instruction was issued.

In Write Result Step 750, the result sent from execution unit 145 may be written into a physical memory. In one embodiment the ready logic in Ready FSM 390 may ensure that the port of the memory array that the result is written into is free. Ready FSM 390 may be configured to only make instructions ready for issue to execution pipelines 135 on cycles in which there will be no resulting conflicts during this step of writing the result. Alternatively, system control logic 130 may be configured to ensure that no two writes occupy the same port of the same physical memory array in an overlapped fashion.

Send MemOp Step 755 is for memory operation type of instructions. In this step, the memory operation to perform, the memory address, the context ID, and optionally the data to write may be made available to the data cache 115. Next may be an Inform ctxt Unit Step 760.

Inform ctxt Unit Step 760 may take an arbitrary amount of time, during which the memory system may be accessed. Upon completion of the operation by the cache 115, the system control logic 130 may inform the Row 310 from which the instruction was issued about this status. The Ready FSM 390 in that row may use this information in its determination of whether that Row 310 is ready to issue its next instruction. Next may be Store? Step 765.

Store? Step 765 is a decision point in the process. If the memory operation is a load (e.g. read data from memory) instruction then the next step may be Write Result Step 770. If it is not a load instruction then that may be the end of execution of that instruction.

Write Result Step 770 is for load instructions. The result retrieved from the memory system may be sent to the register file set 150 where the data may be written into a physical memory array. This may be the end of execution of this instruction. Note that in one optional embodiment, Ready FSM 390 has already ensured that there will be no conflicts on such a write. Note that in embodiments that include floating point units, vector units and other execution pipelines that operate on alternative formats of data, there will be multiple register files in the system, and step 770 may be performed on the register file whose type matches the type of the instruction and therefore type of the execution pipeline, and the register file may physically or logically be the element of the register file set that is associated with the row from which the instruction was issued.

Change Flow? Step 775 is for control flow instructions. It is a decision point in the process. Upon completion of processing on an instruction by execution unit 145 it is known whether the control flow instruction is taken or not. If it is not taken then the next step may be an Inform ctxt Unit Step 780. If it is taken then the next step may be Send New Addr step 785.

Inform ctxt Unit Step 780 optionally uses the system control logic 130 to inform the Row 310 from which the instruction was issued that the branch was not taken. The Fetch FSM 380 may use this information to determine the instruction to place into Ready Instruction Storage 320. This may be the end of execution of this instruction.

Send New Addr Step 785 is for control flow instructions in which alteration of control flow does take place. An example of a control flow instruction is a taken branch instruction and another example is a jump instruction. In the Send New Addr Step 785, system control logic 130 may be used to transfer the new instruction address to the row from which the control flow instruction was issued. This address may be received by Fetch FSM 380 and may determine what instruction is placed into Ready Instruction Storage 320. This may be the end of the execution of this instruction.

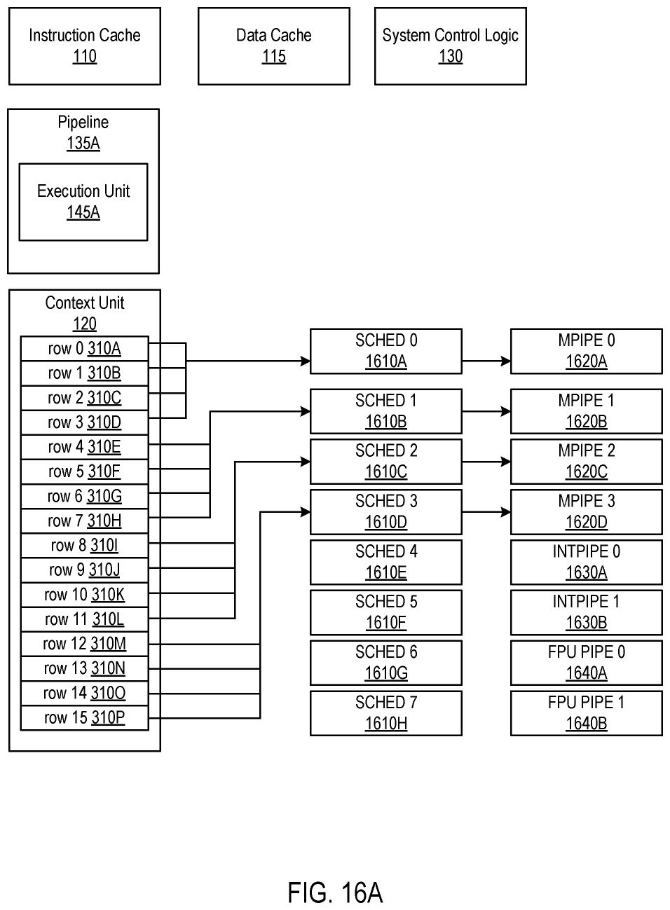

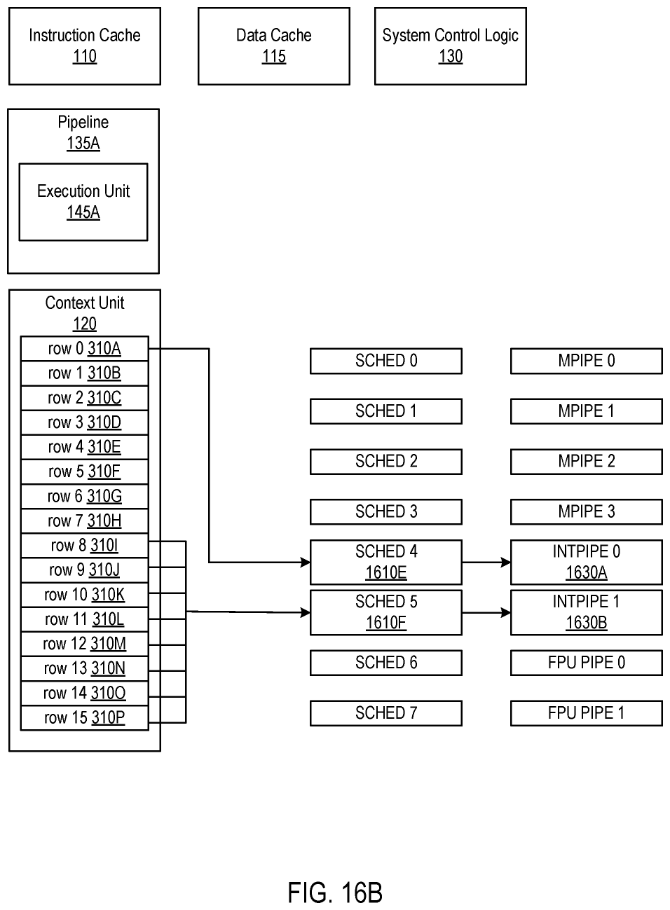

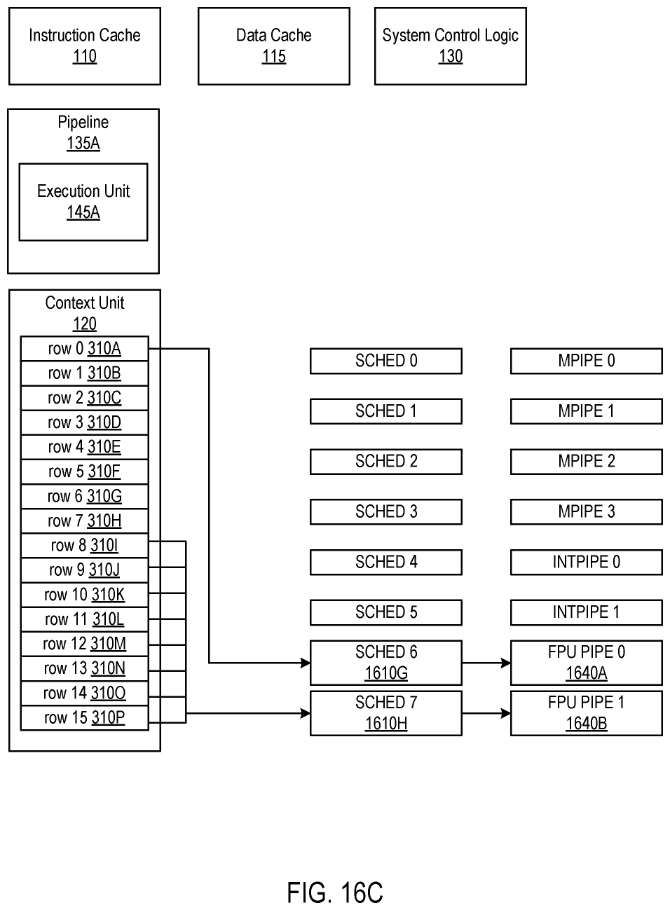

FIGS. 16A-16C depict block diagrams that include a non-limiting example of a core with 16 rows, where a portion of each row may implement a portion of a hardware thread, are shown as respective rows in context unit 120 that may be numbered from 0 through 15. While FIGS. 16A-16C are presented as separate figures, this is for simplicity only and in no way suggest alternative or varying arrangements but rather each figure illustrates a sub-set of wirings that are all included in a single system or single implementation. There may be 4 schedulers for instructions of the memory type shown as SCHED 0-3, 2 schedulers for instructions of the integer type shown as SCHED 4-5, and 2 schedulers for instructions of the FPU type shown as SCHED 6-7.

FIG. 16A shows that rows 0 through 3 (e.g., 310A-D of context unit 120) may connect to scheduler 0 (e.g., scheduler 1610A), which in turn issues to execution pipeline MPIPE 0 (e.g., MPIPE 1620A). Rows 4 to 7 (e.g., rows 310E-H) may connect to scheduler 1 (e.g., scheduled 1610B), which in turn issues to execution pipeline MPIPE 1 (e.g., MPIPE 1620B), and so on. In addition, FIG. 16B shows that rows 0 to 7 (e.g., rows 310A-H) may be connected to scheduler 4 (e.g., scheduled 1610E) which issues to execution pipeline integer 0 (e.g., integer pipeline 1630A), rows 8 to 15 (e.g., rows 310I-P) may connect to scheduler 5 (e.g., scheduled 1610E), which in turn issues to execution pipeline integer 1 (e.g., integer pipeline 1630B). In addition, FIG. 16C shows that rows 0 to 7 (e.g., rows 310A-H) may be connected to scheduler 6 (e.g., scheduled 1610G) which issues to execution pipeline FPU 0 (floating point pipeline 1640A). Rows 8 to 15 (e.g., rows 310I-P) may connect to scheduler 7 (e.g., scheduler 1610H), which in turn issues to execution pipeline FPU 1 (e.g., floating point pipeline 1640B).

An alternative embodiment may be to use full or partial cores instead of rows from a context unit. Such a full or partial core may be similar to a single cycle microcontroller style core, or a classic RISC pipeline which is an instruction pipeline that may be similar to INSTR PIPE 1101, or a more sophisticated pipeline, even something like an out of order core such as one that has been configured with only a small number of reservation stations. Such a full or partial core may be characterized by 1) a multi-stage pipeline and/or 2) very few logic gates as compared to typical out of order cores. Such a full or partial core is herein referred to as a “simple core”. An example of a classic RISC pipeline may be MIPS, SPARC, Motorola 88000, and DLX.

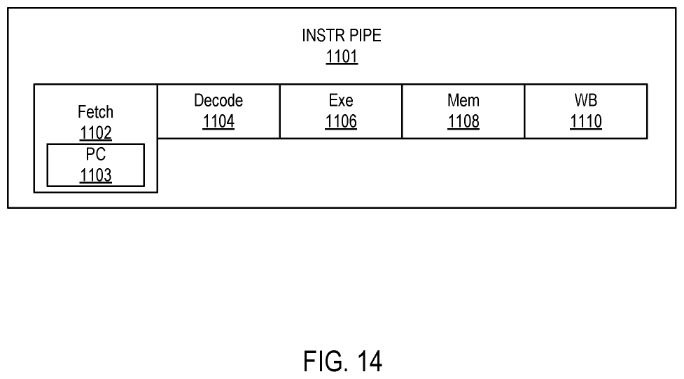

FIG. 14 depicts a block diagram of the elements of a classic RISC pipeline, which may include 1) Program Counter (shown as PC 1103), 2) fetch stage 1102, 3) decode stage 1104 which may also perform register read, 4) execution stage 1106, and 5) memory stage 1108 during which an address and optionally data may be sent to memory and then optionally wait for data to come back 6) register write back 1110.

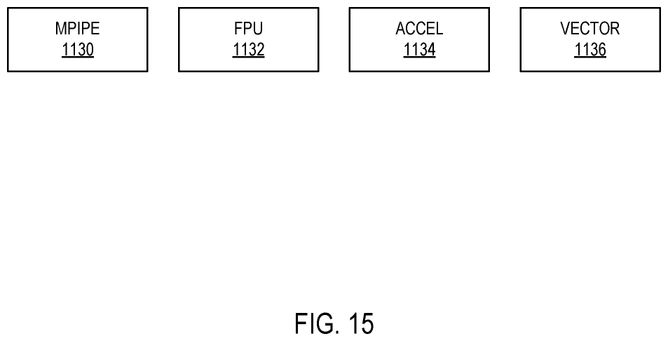

FIG. 15 depicts a block diagram of one or more execution units that may be found in common Enterprise Class CPUs: 1) Floating point unit or FPU 1132, MPIPE, which may include a memory management unit (MMU) and or may include one or more translation lookaside buffers, and or may include a level one cache for data AKA “L1 data cache” 115, 3) a vector unit 1136, and 4) an accelerator 1134, which may be one of several types: i) Neural Network Accelerator ii) compression accelerator iii) encryption accelerator or any other common function that the designer wishes to support with a specialized circuit.

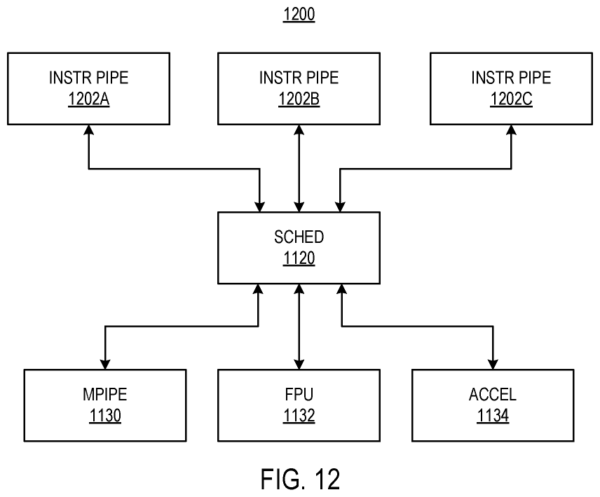

FIG. 12 depicts a system 1200 having multiple instruction pipelines 1202A-C. The instruction pipelines or INSTR PIPE 1202A-C may be modified such that a shared scheduler 1120 (shown as SCHED 1120) is added to the system and connected to the instruction pipelines and the scheduler may also be also connected to one or more circuits to be shared. In this example the shared circuits are an MPIPE 1130, an FPU 1132, and the accelerator 1134 (shown as ACCEL 1134). The instruction pipelines may share such circuits by utilizing the added common scheduler (e.g., the SCHED 1120). Such a scheduler may be a fair scheduler. Each such instruction pipeline may add a pipeline stage during which an instruction that uses one of the shared circuit types (AKA “execution unit” AKA “function unit” AKA “execution pipeline” or simply “pipeline”) is offered to the scheduler. The scheduler 1120 may choose from among the offered and ready (ready may mean free from hazards) instructions and issue the chosen instruction to that circuit type. The scheduler 1120 may also issue separate instructions to more than one execution pipeline in the same cycle. Note that context units can be connected in the same fashion as instruction pipelines, thus a portion or all of a row 310 of a context unit 120 may replace a portion or all of an instruction pipe 1202 in FIG. 12.

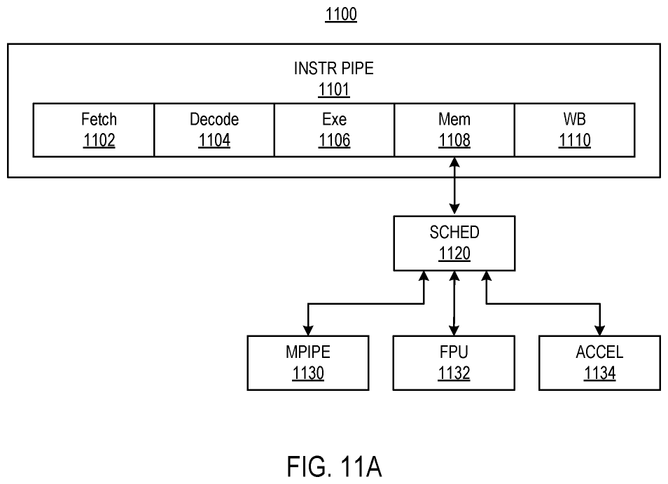

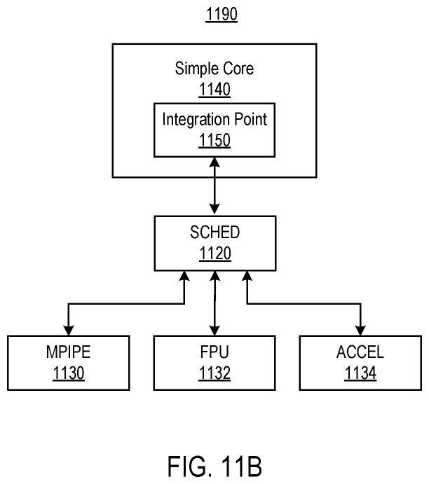

FIG. 11A depicts system 1100 that includes an example of an instruction pipeline 1101 attached to a shared scheduler (e.g., the SCHED 1120) which may be issue logic and thereby gaining access to shared execution units. In such a system, an instruction pipeline may use the MEM pipeline stage 1108 for multiple purposes, including sending a Ld (load) or St (store) operation to the shared MPIPE 1130, or alternatively sending a floating point instruction to the shared FPU 1132, or sending a vector instruction to the shared vector unit, or sending an operation to an AI accelerator (e.g., the Accel 1134) or an innerloop accelerator or some other type of accelerator, and so on. Such a modified pipeline stage may wait for the instruction offered to be executed and a response returned to the pipeline stage, which may alternatively stall the pipeline while waiting and clearing the stall when the response arrives back to the pipeline stage. In alternative embodiments, rather than stall the pipeline stage 1108 the pipeline stage may process hazards in similar fashion to how a ready FSM 390 processes hazards and thereby only stall when the next instruction is not ready to be issued. In alternative embodiments, rather than modify the MEM pipeline stage 1108, a different pipeline stage other than MEM may be used, or a new pipeline stage may be added where the new pipeline stage may be used to offer instructions or simply offer operations to the scheduler. In alternative embodiments, the response may arrive back to the WB stage (e.g., WB 1110) or one of the other stages in the instruction pipeline 1101.

FIG. 11B illustrates a system 1190 that includes a simple core 1140 attached to a scheduler 1120 to which it may offer instructions to be executed, wherein the scheduler is in turn attached to multiple execution pipelines. The scheduler 1120 chooses from among the offered instructions and issues the chosen instructions to one or more of the execution pipelines. The concept and pattern are similar to those described and shown in FIG. 11A, with the difference being that a simple core may not have a pipeline or a simple core may contain a pipeline that may not match the five stages shown for INSTR PIPE 1101 in FIG. 11A. The means to attach a simple core to a scheduler 1120 may be different than modifying a pipeline stage.

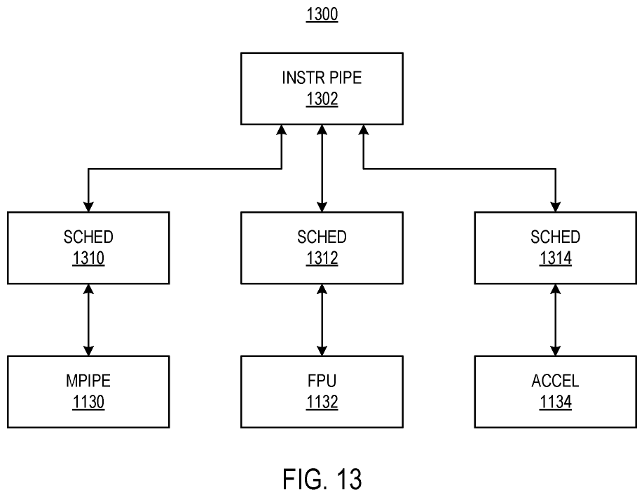

The instruction pipelines 1202A-C may be conceptually grouped such that a group can share the same execution pipeline, for example FPU 1132. A given instruction pipeline may be part of multiple groups. IE a given instruction pipeline may be connected to multiple schedulers as shown in FIG. 13, and thereby may be able to send operations to multiple shared execution units. The benefit of such sharing of common execution pipelines by multiple instruction pipelines is that the amount of silicon is reduced. For workloads that require the shared execution unit, it is common that only a fraction of the instructions use that execution unit. If each instruction pipeline had its own copy of the execution unit, then the silicon devoted to each one of those execution units would remain unused for most of the cycles. Thus, sharing such execution units has economic (e.g., less materials, smaller chip size, less components, etc.) benefit by achieving the same or nearly the same performance with less silicon area. The same pattern may apply by substituting a simple core in place of an instruction pipeline.

FIG. 13 shows a subsystem 1300 that represents alternative ways of attaching a representative instruction pipeline 1302 which is equivalent to any of 1202A-C. The same pattern may apply by substituting a simple core in place of an instruction pipeline. FIG. 13 illustrates that any of the instruction pipelines (instr pipe 1302) may be connected to multiple schedulers 1310, 1312, 1314. Each of the schedulers may be connected to one or more execution pipelines. FIG. 13 shows a single execution pipeline attached to a single scheduler. Instruction pipelines may be connected to schedulers and hence share execution pipelines in the same way that rows in context unit 120 may be connected to multiple schedulers and hence to multiple execution units. Thus FIGS. 16A, 16B, and 16C also apply to simple cores, where the simple cores have functionality that is used instead of a portion of a row of the context unit 120 in FIGS. 16A-C. Note that FIG. 13 applies to rows of a context unit as well as simple cores. In FIG. 13, instr pipe 1302 may optionally be replaced by a row of context unit 120.

The term “scheduler” is defined as logic to which instructions are offered, and the logic chooses from among the offered instructions, and then issues the chosen instruction or instructions to other logic which then manages or directly executes the operation of the instruction.

To define the term “fair ready-scheduler” we first give a non-limiting example. In the example, the system has 4 hardware threads that feed a common scheduler. Each hardware thread indicates whether it has a valid offer to be scheduled. Over the course of a large number of cycles, such as one billion selection events or more, record which of the (example) 4 hardware threads are offering a ready instruction during the cycle and record which hardware thread was chosen during the cycle. Filter the recording into collections. One collection contains all cycles in which only hardware thread 1 and hardware thread 2 make an offer. A second collection contains all cycles in which only hardware thread 1 and hardware thread 3 make an offer. And so on and so forth for all combinations of two out of the 4 hardware threads. Likewise, one collection for each combination of 3 out of the 4 hardware threads. Likewise, one collection where all 4 hardware threads make an offer to the scheduler. There is no need to make any collections for cycles in which only a single hardware thread made an offer because the one hardware thread that is making an offer will be chosen every time by a completely fair ready scheduler. And, of course, no collection is needed for cycles in which no offer was made by any hardware thread, as no hardware thread is chosen on such cycles. Once the filtering of the cycles is complete, then we have this state: the filtering has resulted in the collections stated, where each collection has every cycle in which that collection's defining set of hardware threads made an offer. Given those collections of cycles, within each stated collection, for a fair ready-scheduler, the pattern of which hardware thread was chosen by the scheduler will be consistent with the pattern seen when the hardware thread is chosen according to a uniform probability distribution.

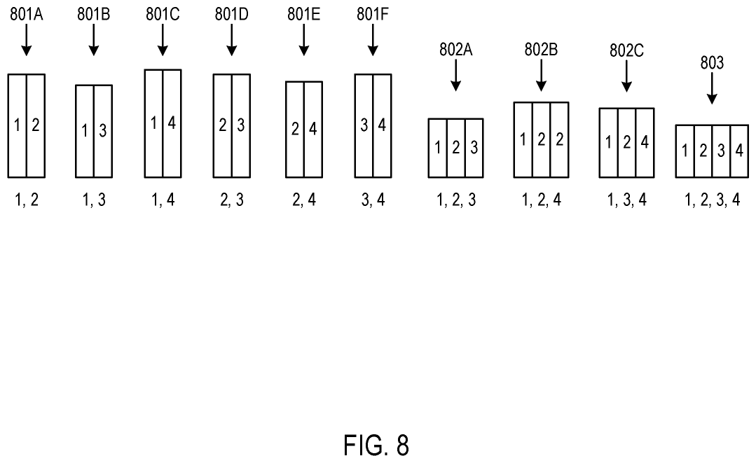

The above example is illustrated in FIG. 8 where 801A-F each refer to the bars generated from the collections that each have only two hardware threads, 802A-C each refer to the bars generated from the collections that each have only three hardware threads, and 803 refers to the bars generated from the collection that has all four hardware threads. In each of 801, 802 and 803, each bar is labelled with the hardware thread that the bar represents. The height of the bar is the number of times that hardware thread's offer was chosen by the scheduler. As an illustrative example, 801A refers to two bars, one bar for hardware thread 1 and the second bar for hardware thread 2. The two bars in 801A are for the collection of all cycles in which hardware thread 1 and hardware thread 2 were the two hardware threads that made an offer. The height of each bar represents the number of times that particular hardware thread was chosen within the collection. The two bars are the same height, or the difference is within the statistics of a uniform distribution. Note that among 801A-F the bars are not all the same height, likewise for 802A-C and 803. In general, the bars for one pair of hardware threads may be lower than for a different pair of hardware threads, which is because there may be different programs run on one pair of hardware threads versus the programs run on a different pair of hardware threads, or the data on which the software thread assigned to a hardware thread computes may cause different behavior from the other hardware threads, and so the total number of cycles for one collection may be different than the total number of cycles for a different collection. However, within a single collection, for a fair scheduler, the height of the bar for each hardware thread will be the same as for the other hardware threads within that collection, to within the statistics that would be gathered if on each hardware thread of the collection the context unit hardware thread were chosen according to a uniform distribution.

Fair Ready Scheduler is defined to be the generalization, of the above example, to any number of hardware threads. The generalization is made by making a collection for each possible subset of hardware threads, and populating each such collection with the cycles on which that collection's defining set of hardware threads made offers. Once the filtering of the cycles is complete, then each collection has every cycle in which that collection's defining set of hardware threads made an offer. Given those collections of cycles, within each stated collection, for a fair ready-scheduler, the count of how many times each hardware thread in that collection's defining set of hardware threads is chosen will be the same for all hardware threads within the defining set, but with small variations in count where the variation is consistent with choosing on each cycle according to a uniform probability distribution.

Note that patterns in one particular program or one particular input data fed to that program may cause deviations from a uniform distribution, but over a large number of cycles, and a large number of programs and a large number of data set inputs, the pattern of choice of hardware thread made by a “fair ready-scheduler” will be consistent with choosing from among the ready hardware threads (within each collection), on each cycle, according to a uniform probability distribution.

We define the term “nearly fair ready-scheduler” to be a scheduler for which, for every set, the distribution of which hardware thread was chosen will be consistent with the pattern seen when the hardware thread is chosen (from among ready hardware threads) according to a nearly uniform probability distribution. A nearly fair ready-scheduler can favor one or more hardware threads over others. A “nearly uniform probability distribution” implies a distribution where the probabilities of different outcomes are approximately equal, but not perfectly so. This means that while no single outcome is overwhelmingly favored, there is still a slight variation in the probabilities compared to a perfectly uniform distribution.

As an example, a nearly fair ready-scheduler, in one of the two hardware thread collections 801A-F, may select a first hardware thread 52 percent of the time and a second hardware thread 48 percent of the time. As another example, a nearly fair ready-scheduler may select, in a four hardware thread scenario 803, a first hardware thread 28 percent of the time, a second hardware thread 26 percent of the time, a third hardware thread 24 percent of the time, and a fourth hardware thread 22 percent of the time.

A non-uniform scheduler is one in which the scheduler displays behavior that is consistent with a non-uniform distribution. For such a non-uniform scheduler, if one produced the equivalent of FIG. 8 for that scheduler, the heights of the bars would not be equal nor nearly equal, rather one or more may be significantly higher than others. One reason to choose a non-uniform scheduler may be in order to provide the user with the ability to purposely increase the probability of choosing one or more particular hardware threads versus other hardware threads (in which case, the “preferred” hardware thread or hardware threads will be chosen with higher probability than other hardware threads). Alternatively, a non-uniform scheduler may be chosen due to implementation constraints or other practical or logistical constraints present in the implementation or manufacturing process.

Several embodiments are specifically illustrated and/or described herein. However, it will be appreciated that modifications and variations are covered by the above teachings and within the scope of the appended claims without departing from the spirit and intended scope thereof. For example, as used herein physical memory arrays can include an SRAM array, or an array of flip flops or latches or an array of transistors arranged as specialized register bit cells.

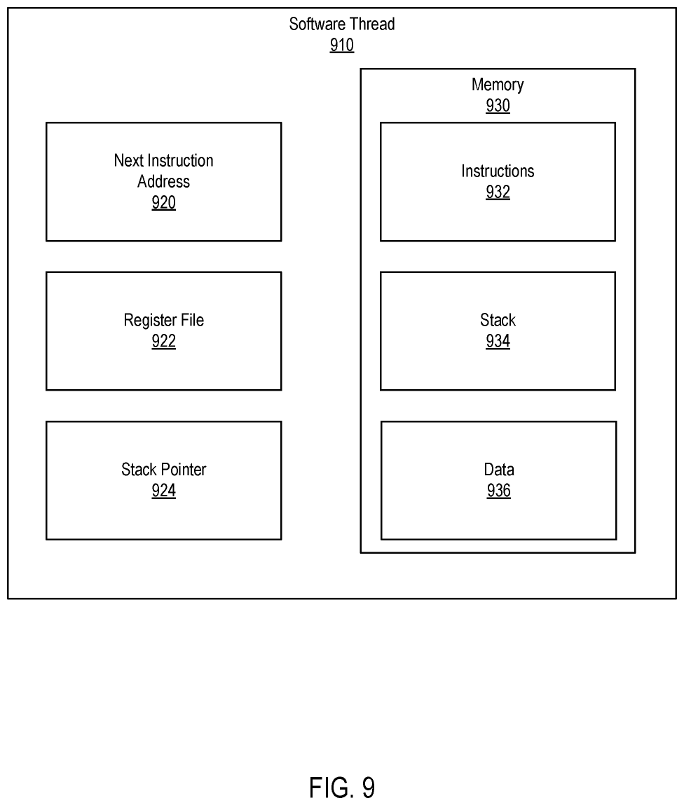

FIG. 9 illustrates elements of a software thread 910. The semantics of a software thread, also known as an instruction thread, are defined by the instruction set architecture of the instructions that are executed. The semantics for most commercial instruction sets are in terms of sequential execution, one instruction at a time, which breaks time into discrete steps. Semantically, for most commercial instruction sets, the complete state of execution of a software thread at each step of time consists of: 1) the contents of memory that consists of the instructions of the program to be executed, shown as stored program 932 2) the address of the instruction for which to complete execution next, shown as next instruction address 920, 3) the contents of the register file that the instruction may take as input (if the instruction specifies inputs from the register file) and which the instruction may modify with its result (if modification of the register file is specified by the instruction), shown as register file 922, 4) the stack 934, where the semantics of many instruction set architectures or the software environment on top of the instruction set architecture also include what is commonly referred to as the “stack” which may consist of locations in memory whose contents may hold Local variables, arguments passed to functions, values returned from a function, the return address of a function call, temporary values stored on the stack during function execution, past states of registers in the register file, and so on, 5) what is commonly referred to as the “stack pointer” which is the address of the current position of the “top of the stack”, which is used to access things stored on the stack, shown as stack pointer 924. Note that the instruction set architecture (ISA) defines the correct behavior of a software thread but the ISA does not indicate the physical implementation. For example, a classic RISC pipeline and an Enterprise class out of order CPU both implement the same semantics of a software thread, but with vastly different hardware.

A hardware thread is defined as hardware that can have a software thread assigned and causes the stream of instructions within that software thread to move forward in the same sequence that would result from applying the semantics of the instruction set architecture to the same program, data, and starting state, and given the same execution unit implementation (to within any inherent ambiguity present in the instruction set architecture). In other words, a hardware thread can be thought about as the hardware that makes the stream of instructions move forward. It is analogous to time, where each instruction in the stream is viewed as one step of time. Hardware is required that performs that function of moving time of the software thread forward. A hardware thread generally does not include the execution units, which implement the semantics of each particular instruction, and a hardware thread generally does not include the issue logic that chooses an instruction from among the hardware threads. For example, a hardware thread can be implemented such that part of the implementation is a finite state machine that processes hazards and determines when instructions are safe to be issued and offers those instructions to issue logic. This finite state machine is part of the logic that moves the software thread forward. Likewise, the implementation of a hardware thread may include both a finite state machine that processes hazards and a finite state machine that performs fetch of instructions and handing off those instructions in the order in which they are to be executed. Both of these finite state machines are performing the act of moving the software thread forward. Concretely, a row of context unit 120 can be viewed as implementing a portion of a hardware thread.

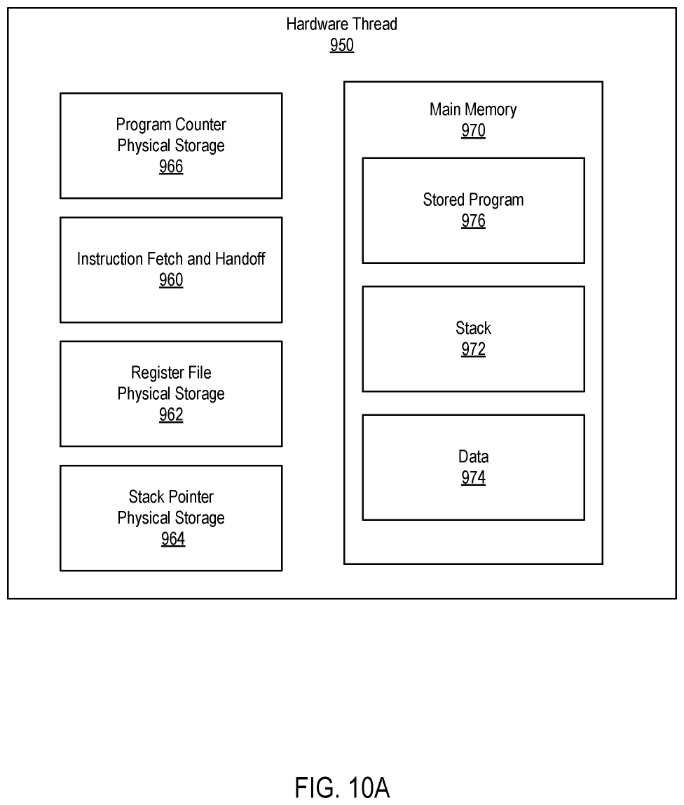

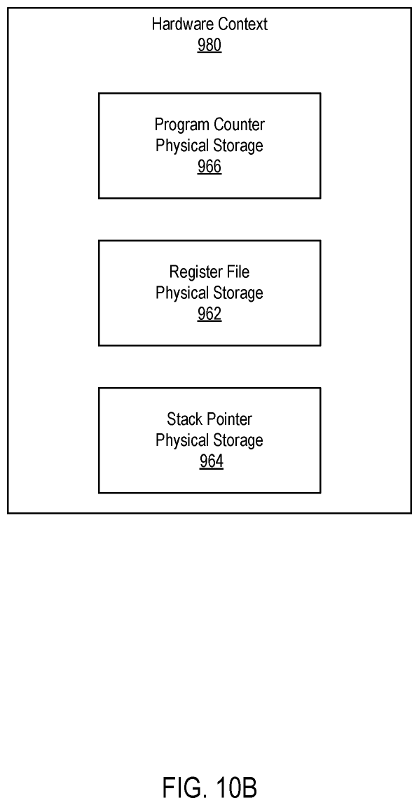

FIG. 10A illustrates one example of common features of a hardware thread 950. Instruction fetch and handoff 960 represents hardware that performs the action of fetching one or more instructions that come next in the semantic sequence of the software thread. Hardware thread 950 hands those instructions off to hardware, which is not part of the hardware thread, that in turn chooses one or more instructions from among the hardware threads (which may be a scheduler) and then executes the semantic operation defined for those instructions (which may take place inside an execution pipeline).

A hardware thread may optionally determine readiness of the instruction before handing the instruction off to the hardware that chooses from among the hardware threads. For some microarchitectures such as out of order, the fetch may include instructions that are predicted to be next, for other microarchitectures, it may include instructions that are simply fetched from main memory because it is easier in the hardware to fetch them, in either example, such instructions might never be executed due to mis predictions or due to jumps or other changes in the instruction sequence. Instruction fetch and handoff 960 may be implemented with flip flops or with SRAMs plus logic and the implementation may fit what may commonly be considered elements of a finite state machine.

Register file physical storage 962 represents a circuit or circuits that implement storage, such as flip flops or SRAM or specialized register file cells on an integrated circuit. An address applied to the storage allows reading or writing the memory. The number of logical addresses and logical width of the data written to and read from this storage is defined by the instruction set architecture (but the physical implementation may differ from the logical configuration defined by the instruction set architecture). Stack pointer 964 may represent physical storage, similar to the circuit types used for register file physical storage 962, where this storage may specifically hold the address of the top of the stack, or the equivalent for the software framework or instruction set being implemented.

The stack pointer 964 may alternatively be a particular register number out of the plurality of registers in the register file physical storage 962, or some other variation on hardware implementation that has the functionality of holding the address of the top of the stack or equivalent means by which to access the stack. Main Memory 970 represents the main working storage of the computing system, such as DRAM. Collections of addresses inside main memory 970 contain data, instructions, and register contents.

Stored program 976 may represent the collection of addresses in main memory that holds the instructions of the stored program that is being executed by a hardware thread 950. The execution by the hardware thread 950 generates a sequence of addresses within stored program 976 according to the semantics of a software thread 910 and hands those off to be executed. Stack 972 may be a collection of addresses in main memory that physically hold the data that may be semantically on the logical stack of the software thread that the hardware thread is executing. Data 974 is a collection of addresses in main memory that physically hold data upon which the software thread is semantically executing.

Note that there are some complexities of the definition of a hardware thread. First, some portions of a hardware thread are physically unique to a particular hardware thread, for example a register file can in some implementations be distinct, such that each hardware thread has its own physically separate register file, likewise each hardware thread may have its own separate stack pointer physical storage. However, there is a large variety of implementations of hardware threads. Some implementations may have one large physical register file that is shared among multiple hardware threads, along with a table that maps the register addr specified by an instruction from one software thread (and hence an instruction from one hardware thread that is executing the software thread) into a larger address within the larger physical register file, which is common practice in multithreaded out of order microarchitectures.

Thus the elements in hardware thread 950 may or may not be physically distinct between different hardware threads in the same processor. Second, a single hardware thread may be multiplexed across multiple software threads. Each software thread will have a collection of addresses that hold the instructions of the stored program 932 for the software thread, where each software thread may have a distinct set of addresses from the other software threads, or two or more software threads may have one or more addresses of their stored program in common with other software threads.

Likewise multiple software threads may have distinct addresses for their data 936 or may share some or all of their addresses with other software threads. However, the stack 934 is typically unique to each software thread, as the stack normally contains data that implies the history of that particular software thread. When a hardware thread is executing a particular software thread, then the stored program 976 of the hardware thread may be a physical embodiment of the semantic stored program 932 for the software thread and may be so for the particular software thread that is being executed at the time.

When the software thread changes, the stored program 976 will switch to a different set of addresses, and then the stored program 932 for the new software thread is part of the hardware thread as the stored program 976. As a consequence of the multiplexing of software threads onto hardware threads, at the point in time when a hardware thread is executing a particular software thread, all the elements of the hardware thread 950 are considered part of that hardware thread.

However, this does not imply that the elements that are part of one hardware thread at a particular point in time, such as the stored program, are physically part of that hardware thread for all time. This applies to the implementation of hardware threads on a semiconductor chip or in an FPGA or other medium. There will be elements of a hardware thread that are indeed physically distinct to each hardware thread and there are likely to be elements of a hardware thread that are only transiently part of that hardware thread during some portion of time, an example of which is the addresses that hold the stored program that the hardware thread is executing. Note that the context ID may be the identifier for the physically distinct portions of one particular hardware thread.

A hardware context is defined to consist of hardware that maintains at least a portion of the state of execution of a software thread and includes storage such as flip flops or registers that hold enough of the state of a software thread that the software thread can be executed and can be swapped into and out of any particular hardware context one or more times, without causing incorrect results to be computed. A hardware context may consist of the portions of stateful portions a hardware thread that are distinct to one and only one hardware thread. Note that a hardware context is a subset of a hardware thread.

FIG. 10B illustrates an exemplary arrangement of a hardware context 980. FIG. 10B shows that only state is part of a hardware context. Note that hardware context includes only distinct physical elements from FIG. 10A that both store state and are unique to a single hardware thread. Notably, main memory is hardware, but the physical hardware is shared by multiple hardware threads. Each hardware thread has its own portion of the shared main memory that stores state that is unique to that hardware thread, such as the stack, which means that the main memory hardware is not distinct to only a single hardware thread and so main memory is not part of a hardware context. The main memory is not part of a hardware context, even though there is data (state) in main memory that is associated with the hardware thread of which the hardware context is a subset. Also note that the logic of instruction fetch and handoff 960 that performs the action of fetching instructions is also not part of a hardware context, even though such logic may indeed be part of the hardware thread of which the hardware context is a subset.

The term “row” as used in this disclosure is related to a hardware context. A row may implement portions of a hardware context. Likewise, a hardware context may include more hardware than just what is part of a row. An example would be that a row in one particular example implementation may consist of two finite state machines, while a hardware context associated with that row may include only a few elements of that row and in addition may also include a physically distinct register file.

As an illustrative, but not limiting, example, a HW thread (hardware thread) may be implemented with 1) a register that holds an index into a block of instructions, plus a register that holds an address in memory of the start of that block of instructions, plus local storage that holds a copy of that block of instructions, all of which together has the overall effect of upholding the semantics of “the address of the next instruction to execute” 2) a separate SRAM for each HW thread that holds the register file state that is defined by the Instruction Set Architecture, 3) state of meta registers, often called Control and Status Registers 350 4) the stack may not be separate hardware, and so may not be part of the HW context, but is still part of the hardware thread, even though the data of the stack is held in main memory. Note that in this case responsibility may be given to the operating system or control software to ensure that the stack area of main memory for one software thread is only modified by instructions that appear in that software thread, while the programming language implementation may be given responsibility for managing access to the stack and manipulating the stack pointer. Note that the implementation of a HW thread only has to uphold the semantics of a software thread but does not have to have a one to one correspondence to elements stated in the software thread semantics. For example, a classic RISC pipeline has a single register, called a program counter, that holds the address of the next instruction to be executed. But a HW thread may, for example, alternatively have an index into a block of instructions, and have an address in memory of the start of that block of instructions, and the block of instructions is a local copy, all of which together has the overall effect of upholding the semantics of “the address of the next instruction to be executed”. A row of context unit 120 implements many of the elements of a hardware thread.

At least one embodiment relates to a system. The system can include a plurality of hardware threads, one or more schedulers, and one or more execution pipelines. At least one hardware thread of the plurality of hardware threads can include one or more finite state machines. At least one finite state machine of the one or more finite state machines can be of a first type. The at least one finite state machine can process hazards on instructions. The at least one finite state machine can determine cycles in which the instructions are safe to issue to at least one of the one or more execution pipelines.

At least one embodiment relates to a system. The system can include a plurality of simple cores, one or more schedulers, and one or more execution units. At least one simple core of the plurality of simple cores can offer instructions to the one or more schedulers. The one or more schedulers can (i) choose from among the offered instructions and (ii) issue at least one instruction chosen from the offered instructions to at least one execution unit of the one or more execution units. The at least one issued instruction can be executed by the at least one execution unit.

At least one embodiment relates to a method. The method can include determining, by at least one hardware thread, cycles in which an instruction from a software thread associated with the at least one hardware thread is ready to be executed within at least one execution pipeline of one or more execution pipelines. The method can include offering, by the at least one hardware thread, the instruction to one or more schedulers. The method can include choosing, by the one or more schedulers, from among one or more instructions offered to the one or more schedulers, at least one instruction. The method can include issuing, by the one or more schedulers, the at least one chosen instruction to an execution pipeline of the one or more execution pipelines. The at least one chosen instruction can be executed by the execution pipeline.

At least one embodiment relates to a method. The method can include requesting, by each fetch finite state machine of a plurality of fetch finite state machines of a device, a block of instructions from one or more locations in memory that hold instructions. The method can include selecting, by each fetch finite state machine, responsive to receiving the requested block of instructions, one or more instructions from a locally stored copy of the requested block of instructions. The method can include offering, by each fetch finite state machine, the one or more instructions to at least one ready finite state machine of a plurality of ready finite state machines of the device. The method can include determining, by each ready finite state machine of the plurality of ready finite state machines, that at least one instruction of the one or more instructions offered is free from hazards. The method can include offering, by each ready finite state machine, the at least one instruction to at least one instance of issue logic of a plurality of instances of issue logic of the device. The method can include selecting, by each instance of issue logic of the plurality of instances of issue logic, from one or more second instructions offered to the at least one instance of the issue logic, the at least one instruction for execution by an execution pipeline of the device.

At least one embodiment relates to a device. The device can include at least one first instance of logic. The at least one first instance of logic can fetch one or more instructions in accordance with a software thread. The device can include at least one second instance of logic. The at least one second instance of logic can accept, from the at least one first instance of logic, one or more instructions offered by the at least one first instance of logic. The one or more offered instructions are from the one or more fetched instructions. The at least one second instance of logic can determine ready status for the one or more accepted instructions responsive to one or more details and statuses of previously issued instructions that have not completed. The at least one second instance of logic can offer ready instructions to one or more instances of issue logic. The device can include the one or more instances of issue logic. The one or more instances of issue logic can choose one or more instructions from among the offered ready instructions. The one or more instances of issue logic can issue the one or more chosen instructions that were chosen from among the offered ready instructions to one or more execution pipelines.

The embodiments discussed herein are illustrative of the present disclosure. As these embodiments of the present disclosure are described with reference to illustrations, various modifications or adaptations of the methods and or specific structures described may become apparent to those skilled in the art. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

Computing systems referred to herein can comprise an integrated circuit, a microprocessor, a personal computer, a server, a distributed computing system, a communication device, a network device, or the like, and various combinations of the same. A computing system may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The various examples of logic noted above can comprise hardware, firmware, or software stored on a computer-readable medium, or combinations thereof. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The logic discussed herein may include hardware, firmware and/or software stored on a non-transient computer readable medium. This logic may be implemented in an electronic device to produce a special purpose computing system.

What is claimed is:

1. A system, comprising:
a plurality of hardware threads, one or more schedulers, and one or more execution pipelines wherein at least one hardware thread of the plurality of hardware threads is configured to contain one or more finite state machines, wherein at least one finite state machine of the one or more finite state machines is of a first type and is configured to process hazards on instructions and determine cycles in which the instructions are safe to issue to at least one of the one or more execution pipelines.

2. The system of claim 1, wherein an implementation of the at least one hardware thread of the plurality of hardware threads includes elements of a hardware context.

3. The system of claim 1, wherein the at least one hardware thread is partially implemented by a row of a context unit.

4. The system of claim 1, wherein the at least one hardware thread contains at least one second finite state machine of a second type that initiates fetch of instructions and feeds the fetched instructions to the at least one finite state machine of the first type.

5. The system of claim 1, wherein at least one scheduler of the one or more schedulers is a fair scheduler.

6. The system of claim 1, wherein at least one scheduler of the one or more schedulers is a nearly fair scheduler.

7. The system of claim 1, wherein at least one scheduler of the one or more schedulers is a non-uniform scheduler.

8. The system of claim 1, further comprising feedback from the one or more execution pipelines to the plurality of hardware threads wherein the feedback indicates a state of processing of instructions within the one or more execution pipelines and the feedback is incorporated into calculation of readiness of instructions to be offered to the one or more schedulers.

9. A system, comprising:
a plurality of simple cores, one or more schedulers, and one or more execution units;
wherein at least one simple core of the plurality of simple cores is configured to offer instructions to the one or more schedulers, and wherein the one or more schedulers (i) choose from among the offered instructions and (ii) issue at least one instruction chosen from the offered instructions to at least one execution unit of the one or more execution units, and wherein the at least one issued instruction is executed by the at least one execution unit.

10. The system of claim 9, further comprising:
the at least one simple core of the plurality of simple cores includes a classic RISC pipeline in which one or more pipeline stages are modified to offer an instruction of the offered instructions to at least one scheduler of the one or more schedulers.

11. The system of claim 10, wherein the one or more modified pipeline stages are configured to:
offer the instruction of the offered instructions to the at least one scheduler of the one or more schedulers; and
stall the classic RISC pipeline responsive to constraints being satisfied.

12. A method, comprising:
determining, by at least one hardware thread, cycles in which an instruction from a software thread associated with the at least one hardware thread is ready to be executed within at least one execution pipeline of one or more execution pipelines;
offering, by the at least one hardware thread, the instruction to one or more schedulers;
choosing, by the one or more schedulers, from among one or more instructions offered to the one or more schedulers, at least one instruction; and
issuing, by the one or more schedulers, the at least one chosen instruction to an execution pipeline of the one or more execution pipelines, wherein the at least one chosen instruction is executed by the execution pipeline.

13. A method, comprising:
requesting, by each fetch finite state machine of a plurality of fetch finite state machines of a device, a block of instructions from one or more locations in memory that hold instructions;
selecting, by each fetch finite state machine, responsive to receiving the requested block of instructions, one or more instructions from a locally stored copy of the requested block of instructions;
offering, by each fetch finite state machine, the one or more instructions to at least one ready finite state machine of a plurality of ready finite state machines of the device;
determining, by each ready finite state machine of the plurality of ready finite state machines, that at least one instruction of the one or more instructions offered is free from hazards;
offering, by each ready finite state machine, the at least one instruction to at least one instance of issue logic of a plurality of instances of issue logic of the device; and
selecting, by each instance of issue logic of the plurality of instances of issue logic, from one or more second instructions offered to the at least one instance of the issue logic, the at least one instruction for execution by an execution pipeline of the device.

14. The method of claim 13, wherein the requested block of instructions is a cache line.

15. The method of claim 13, wherein the at least one instance of issue logic of the plurality of instances of issue logic selects the execution pipeline based on the execution pipeline matching a type of instruction of the at least one instruction.

16. A device, comprising:
at least one first instance of logic configured to:
fetch one or more instructions in accordance with a software thread;
at least one second instance of logic configured to:
accept, from the at least one first instance of logic, one or more instructions offered by the at least one first instance of logic, wherein the one or more offered instructions are from the one or more fetched instructions;
determine ready status for the one or more accepted instructions responsive to one or more details and statuses of previously issued instructions that have not completed; and
offer ready instructions to one or more instances of issue logic; and
the one or more instances of issue logic configured to:
choose one or more instructions from among the offered ready instructions; and
issue the one or more chosen instructions that were chosen from among the offered ready instructions to one or more execution pipelines.

17. The device of claim 16, wherein the at least one first instance of the logic is an element of an instruction pipeline.

18. The device of claim 16, wherein the at least one first instance of the logic is an element of a classic RISC pipeline.

19. The device of claim 16, wherein the one or more execution pipelines are configured to execute at least one second instruction type different from and in addition to an instruction type of the one or more chosen instructions issued to the one or more execution pipelines.

20. The device of claim 16, wherein the ready status is based on one or more sources of hazards that include at least one hazard with respect to a register file access.

21. The device of claim 16, wherein the one or more chosen instructions are selected in a way that is fair to one or more hardware threads.

22. The device of claim 16, wherein the at least one second instance of logic is configured to set the ready status to false, responsive to a determination that at least one previously issued instruction is set to write to a register file associated with the software thread during the same cycle as will the one or more accepted instructions having the ready status considered by the at least one second instance of logic if the one or more accepted instructions were marked ready and were the next instruction chosen by the one or more instances of issue logic.

23. The device of claim 16, wherein the one or more details and statuses of the previously issued instructions are in the form of feedback, from the one or more execution pipelines, to the at least one second instance of logic, and wherein calculation, by the at least one second instance of logic, of ready status, is responsive to the feedback.

24. The device of claim 16, wherein the one or more chosen instructions include one or more instruction types, wherein the one or more instances of the issue logic are configured to issue the one or more chosen instructions in accordance with the one or more instruction types such that one or more chosen instructions are issued to respective execution pipelines, of the one or more execution pipelines, that match the one or more instruction types.

25. The device of claim 16, wherein a first execution pipeline of the one or more execution pipelines is associated with a first type of instructions, wherein a second execution pipeline of the one or more execution pipelines is associated with a second type of instructions, and wherein one instance of issue logic of the one or more instances of issue logic is configured to issue each of the one or more chosen instructions to the first execution pipeline or the second execution pipeline, based on an instruction type of the one or more chosen instructions.

26. The device of claim 16, wherein one instance of issue logic of the one or more instances of issue logic is configured to issue, in the same cycle, (i) a first instruction of the one or more chosen instructions to a first execution pipeline of the one or more execution pipelines and (ii) a second instruction of the one or more chosen instructions to a second execution pipeline of the one or more execution pipelines.

27. The device of claim 16, wherein the at least one first instance of logic is configured to:
fetch more than one of the one or more fetched instructions during the same cycle.

28. The device of claim 16, wherein a subset of the one or more fetched instructions are fetched in the form of a cache line and wherein the cache line is stored locally in a first instance of logic.

29. The device of claim 16, wherein the ready status of the one or more accepted instructions is determined based on at least one of:
conflicts on a register write port;
conflicts on a register read port;
conflicts in addresses of instructions that are memory operation type instructions;
backpressure associated with issuance of instructions; or
an exception risk associated with a previous instruction.

30. The device of claim 16, wherein at least one accepted instruction, of the one or more accepted instructions accepted by the at least one second instance of logic, is partially decoded before the at least one accepted instruction is marked as ready.

31. The device of claim 16, wherein at least one accepted instruction of the one or more accepted instructions accepted by the at least one second instance of logic is partially decoded before the at least one accepted instruction is issued.

32. The device of claim 16, wherein the at least one first instance of logic implements a portion of at least one hardware thread.

33. The device of claim 32, wherein the at least one hardware thread includes as least one of:
a register file having an interface consistent with an instruction set architecture; and
a state to track a position of at least one instruction within memory that holds instructions.

34. The device of claim 32, further comprising:
an instruction finite state machine configured to:
fetch the one or more fetched instructions for the software thread associated with the at least one hardware thread; and
provide the one or more fetched instructions to a ready finite state machine.

35. The device of claim 34, wherein the instruction finite state machine is further configured to:
fetch, from a cache, a cache line that includes the one or more fetched instructions; and
save the contents of the cache line in storage local to the instruction finite state machine.

36. The device of claim 32, wherein the one or more fetched instructions include one or more types of instructions.

37. The device of claim 36, wherein the one or more types of instruction include at least one of:
memory operations as defined by an instruction set architecture;
integer operations as defined by an instruction set architecture;
floating point operations as defined by an instruction set architecture; or
vector operations as defined by an instruction set architecture.

38. The device of claim 16, wherein the one or more instances of issue logic are configured to:
choose the one or more chosen instructions such that (i) the one or more chosen instructions are ready and (ii) selection of the one or more chosen instructions from the one or more offered instructions is fair or nearly fair or non-uniform.

39. The device of claim 16, wherein the one or more instances of issue logic are configured to:
issue, within the same cycle, more than one of the one or more chosen instructions.

40. The device of claim 16, further comprising:
the at least one second instance of logic configured to:
extract source register addresses from the one or more accepted instructions; and
send, responsive to extraction, the source register addresses to a register file associated with the software thread, wherein sending the source register addresses initiates a register fetch before the one or more accepted instructions enter the one or more execution pipelines.

41. The device of claim 16, wherein the at least one first instance of logic is a fetch finite state machine.

42. The device of claim 16, wherein the at least one second instance of logic is a ready finite state machine.

43. The device of claim 16, wherein the at least one second instance of logic is configured to determine the ready status based on a history of previous selections of instructions.

44. The device of claim 16, wherein the ready status is determined based at least on hazards.

45. The device of claim 16, wherein at least one instance of issue logic of the one or more instances of issue logic is a fair scheduler, a nearly fair scheduler, or a non-uniform scheduler.

46. The device of claim 16, wherein exceptions must be detected within a maximum number of cycles after issuance of the one or more chosen instructions to the one or more execution pipelines, and wherein the maximum number of cycles is at least one of 1, 2, 3, 4, 5, 6, 7, 8, 9, 10, 11, 12, 13, or 14 cycles.
